(19) United States
(12) Patent Application Publication
(10) Pub. No.: US 2024/0137181 A1
(43) Pub. Date: Apr. 25, 2024

(54) SOUNDING REFERENCE SIGNAL CONFIGURATION AND ACTIVATION FOR PARTIAL FREQUENCY SOUNDING

(71) Applicant: QUALCOMM INCORPORATED, San Diego, CA (US)

(72) Inventors: Runxin Wang, San Diego, CA (US); Muhammad Sayed Khairy Abdelghaffar, San Jose, CA (US); Kexin Xiao, Shanghai (CN); Yu Zhang, San Diego, CA (US)

(21) Appl. No.: 18/547,838

(22) PCT Filed: Apr. 25, 2021
(86) PCT No.: PCT/CN2021/089616

§ 371 Date: Aug. 24, 2023

(51) Int. Cl. H04L 5/00

(52) U.S. Cl. CPC H04L 5/0051; H04L 5/0007

(57) ABSTRACT

Methods, systems, and devices for wireless communications are described. For instance, a user equipment (UE) may receive. from a base station, control signaling for a first sounding reference signal. The UE may determine, based on the configuration and a set of parameters associated with partial frequency sounding of the first sounding reference signal, a subset of a set of re sources configured for the first sounding reference signal, where the subset of the set of resources excludes at least one resource of the set of resources. The UE may transmit, to the base station, a second sounding reference signal over the subset of the set of resources.

### FIELD OF TECHNOLOGY

The following relates to wireless communications, including sounding

reference signal configuration and activation for partial frequency sounding.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

A user equipment (UE) may transmit a sounding reference signal (SRS) to a base station to enable the base station to perform channel estimation (e.g., among other functions). Efficient configuration and transmission of SRS may present challenges.

### SUMMARY

The described techniques relate to improved methods, systems, devices, and apparatuses that support sounding reference signal configuration and activation for partial frequency sounding. Generally, the described techniques provide for a user equipment (UE) to transmit a sounding reference signal over a fewer number of resources relative to resources typically configured for sounding reference signals at the UE. For instance, a UE may receive, from a base station, control signaling for a first sounding reference signal. The UE may determine, based on the configuration and a set of parameters associated with partial frequency sounding of the first sounding reference signal, a subset of a set of resources configured for the first sounding reference signal, where the subset of the set of resources excludes at least one resource of the set of resources. The UE may transmit, to the base station, a second sounding reference signal over the subset of the set of resources.

A method for wireless communication at a user equipment (UE) is described. The method may include receiving, from a base station, control signaling identifying a configuration for a first sounding reference signal, determining, based on the configuration and a set of parameters associated with partial frequency sounding of the first sounding reference signal, a subset of a set of resources configured for the first sounding reference signal, where the subset of the set of resources excludes at least one resource of the set of resources, and transmitting, to the base station, a second sounding reference signal over the subset of the set of resources.

An apparatus for wireless communication at a UE is described. The apparatus may include a processor, memory coupled with the processor, and instructions stored in the memory. The instructions may be executable by the processor to cause the apparatus to receive, from a base station, control signaling identifying a configuration for a first sounding reference signal, determine, based on the configuration and a set of parameters associated with partial frequency sounding of the first sounding reference signal, a subset of a set of resources configured for the first sounding reference signal, where the subset of the set of resources excludes at least one resource of the set of resources, and transmit, to the base station, a second sounding reference signal over the subset of the set of resources.

Another apparatus for wireless communication at a UE is described. The apparatus may include means for receiving, from a base station, control signaling identifying a configuration for a first sounding reference signal, means for determining, based on the configuration and a set of parameters associated with partial frequency sounding of the first sounding reference signal, a subset of a set of resources configured for the first sounding reference signal, where the subset of the set of resources excludes at least one resource of the set of resources, and means for transmitting, to the base station, a second sounding reference signal over the subset of the set of resources.

A non-transitory computer-readable medium storing code for wireless communication at a UE is described. The code may include instructions executable by a processor to receive, from a base station, control signaling identifying a configuration for a first sounding reference signal, determine, based on the configuration and a set of parameters associated with partial frequency sounding of the first sounding reference signal, a subset of a set of resources configured for the first sounding reference signal, where the subset of the set of resources excludes at least one resource of the set of resources, and transmit, to the base station, a second sounding reference signal over the subset of the set of resources.

Some examples of the method, apparatuses, and non-transitory computer-readable medium described herein may further include operations, features, means, or instructions for determining the subset of the set of resources includes determining a position of a resource of a first symbol of a set of symbols and a resource pattern relative to the resource for each other symbol of the set of symbols, where the first symbol occurs before each other symbol of the set of symbols and transmitting the second sounding reference signal includes transmitting the second sounding reference signal over the resource of the first symbol and one or more resources of each other symbol of the set of symbols based on determining the position of the resource of the first symbol and the resource pattern.

Some examples of the method, apparatuses, and non-transitory computer-readable medium described herein may further include operations, features, means, or instructions for receiving an indication of the set of parameters that includes a first parameter, where determining the position of the resource of the first symbol of the set of symbols may be based on the first parameter, where transmitting the second sounding reference signal includes transmitting the second sounding reference signal over the resource of the first symbol based on the first parameter.

Some examples of the method, apparatuses, and non-transitory computer-readable medium described herein may further include operations, features, means, or instructions for receiving an indication of the set of parameters that includes a first parameter, where determining the resource pattern relative to the resource for each other symbol of the set of symbols may be based on the first parameter.

In some examples of the method, apparatuses, and non-transitory computer-readable medium described herein, the resource pattern includes a frequency hopping pattern based on the first parameter failing to satisfy a threshold.

Some examples of the method, apparatuses, and non-transitory computer-readable medium described herein may further include operations, features, means, or instructions for receiving medium access control (MAC) control element signaling that reconfigures the position of the resource, the resource pattern, or both and transmitting a third sounding reference signal according to the reconfigured position of the resource, the reconfigured resource pattern, or both.

Some examples of the method, apparatuses, and non-transitory computer-readable medium described herein may further include operations, features, means, or instructions for receiving the media access control (MAC) control element signaling before transmitting the second sounding reference signal, where transmitting the second sounding reference signal according to the position of the resource of the first symbol and the resource pattern may be based on receiving the MAC control element signaling within a threshold time relative to transmitting the second sounding reference signal, and where transmitting the third sounding reference signal according to the reconfigured position of the resource, the reconfigured resource pattern, or both may be based on receiving the MAC control element signaling prior to the threshold time relative to transmitting the third sounding reference signal.

In some examples of the method, apparatuses, and non-transitory computer-readable medium described herein, the set of resources may be associated with a set of symbols, each symbol of the set of symbols may be associated with two or more resources of the set of resources that may be contiguous with each other, the two or more resources for each symbol may have an order, determining the subset of the set of resources includes determining an index for the each symbol, and a position in the order for the subset of the set of resources for the each symbol may be based on the corresponding index.

In some examples of the method, apparatuses, and non-transitory computer-readable medium described herein, each index may be based on a position of the corresponding symbol relative to each other symbol of the set of symbols.

In some examples of the method, apparatuses, and non-transitory computer-readable medium described herein, each index may be based on a hop number associated with the symbol corresponding to each index.

In some examples of the method, apparatuses, and non-transitory computer-readable medium described herein, the set of resources may be configured for each of a first slot and a second slot that occurs after the first slot and the method, apparatuses, and non-transitory computer-readable medium may include further operations, features, means, or instructions for transmitting, during the second slot, the first sounding reference signal over each resource of the set of resources configured for the second slot.

Some examples of the method, apparatuses, and non-transitory computer-readable medium described herein may further include operations, features, means, or instructions for determining, after transmitting the second sounding reference signal, that a measurement gap may be larger than a threshold, that bandwidth part switching may have occurred, or both, where transmitting the first sounding reference signal over each resource of the set of resources configured for the second slot may be based on determining that the measurement gap may be larger than the threshold, that bandwidth part switching may have occurred, or both.

Some examples of the method, apparatuses, and non-transitory computer-readable medium described herein may further include operations, features, means, or instructions for identifying a sequence of indices associated with a sequence of symbols including respective resources of the subset of the set of resources and refraining from transmitting the second sounding reference signal during a first symbol the sequence of symbols based on identifying a gap including the first symbol, where transmitting the second sounding reference signal includes transmitting the second sounding reference signal in a second symbol of the sequence of symbols subsequent to the gap according to a corresponding index of the sequence of indices.

Some examples of the method, apparatuses, and non-transitory computer-readable medium described herein may further include operations, features, means, or instructions for identifying a sequence of indices associated with a sequence of symbols including respective resources of the subset of the set of resources, refraining from transmitting the second sounding reference signal during a first symbol the sequence of symbols based on identifying a gap including the first symbol, and resetting the sequence of indices at a second symbol subsequent to the gap such that the second symbol may be associated with an initial index of the sequence of indices based on the first symbol being within the gap, where transmitting the second sounding reference signal includes transmitting the second sounding reference signal in the second symbol based on the initial index.

Some examples of the method, apparatuses, and non-transitory computer-readable medium described herein may further include operations, features, means, or instructions for identifying a sequence of indices associated with a sequence of symbols including respective resources of the subset of the set of resources, refraining from transmitting the second sounding reference signal during a first symbol the sequence of symbols based on identifying a gap including the first symbol, and deferring an index of the sequence of indices corresponding to the first symbol to a second symbol subsequent to the gap, where transmitting the second sounding reference signal includes transmitting the second sounding reference signal in the second symbol based on the deferred index.

A method for wireless communication at a base station is described. The method may include transmitting, to a UE, control signaling identifying a configuration for a first sounding reference signal, determining, based on the configuration and a set of parameters associated with partial frequency sounding of the first sounding reference signal, a subset of a set of resources configured for the first sounding reference signal, where the subset of the set of resources excludes at least one resource of the set of resources, and receiving, from the UE, a second sounding reference signal over the subset of the set of resources.

An apparatus for wireless communication at a base station is described. The apparatus may include a processor, memory coupled with the processor, and instructions stored in the memory. The instructions may be executable by the processor to cause the apparatus to transmit, to a UE, control signaling identifying a configuration for a first sounding reference signal, determine, based on the configuration and a set of parameters associated with partial frequency sounding of the first sounding reference signal, a subset of a set of resources configured for the first sounding reference signal, where the subset of the set of resources excludes at least one resource of the set of resources, and receive, from the UE, a second sounding reference signal over the subset of the set of resources.

Another apparatus for wireless communication at a base station is described. The apparatus may include means for transmitting, to a UE, control signaling identifying a configuration for a first sounding reference signal, means for determining, based on the configuration and a set of parameters associated with partial frequency sounding of the first sounding reference signal, a subset of a set of resources configured for the first sounding reference signal, where the subset of the set of resources excludes at least one resource of the set of resources, and means for receiving, from the UE, a second sounding reference signal over the subset of the set of resources.

A non-transitory computer-readable medium storing code for wireless communication at a base station is described. The code may include instructions executable by a processor to transmit, to a UE, control signaling identifying a configuration for a first sounding reference signal, determine, based on the configuration and a set of parameters associated with partial frequency sounding of the first sounding reference signal, a subset of a set of resources configured for the first sounding reference signal, where the subset of the set of resources excludes at least one resource of the set of resources, and receive, from the UE, a second sounding reference signal over the subset of the set of resources.

Some examples of the method, apparatuses, and non-transitory computer-readable medium described herein may further include operations, features, means, or instructions for determining the subset of the set of resources includes determining a position of a resource of a first symbol of a set of symbols and a resource pattern relative to the resource for each other symbol of the set of symbols, where the first symbol occurs before each other symbol of the set of symbols and receiving the second sounding reference signal includes receiving the second sounding reference signal over the resource of the first symbol and one or more resources of each other symbol of the set of symbols based on determining the position of the resource of the first symbol and the resource pattern.

In some examples of the method, apparatuses, and non-transitory computer-readable medium described herein, the set of resources may be associated with a set of symbols, each symbol of the set of symbols may be associated with two or more resources of the set of resources that may be contiguous with each other, the two or more resources for each symbol may have an order, determining the subset of the set of resources includes determining an index for the each symbol, and a position in the order for the subset of the set of resources for the each symbol may be based on the corresponding index.

In some examples of the method, apparatuses, and non-transitory computer-readable medium described herein, the set of resources may be configured for each of a first slot and a second slot that occurs after the first slot and the method, apparatuses, and non-transitory computer-readable medium may include further operations, features, means, or instructions for receiving, during the second slot, the first sounding reference signal over each resource of the set of resources configured for the second slot.

Some examples of the method, apparatuses, and non-transitory computer-readable medium described herein may further include operations, features, means, or instructions for identifying a sequence of indices associated with a sequence of symbols including respective resources of the subset of the set of resources and refraining from receiving the second sounding reference signal during a first symbol the sequence of symbols based on identifying a gap including the first symbol, where receiving the second sounding reference signal includes receiving the second sounding reference signal in a second symbol of the sequence of symbols subsequent to the gap according to a corresponding index of the sequence of indices.

Some examples of the method, apparatuses, and non-transitory computer-readable medium described herein may further include operations, features, means, or instructions for identifying a sequence of indices associated with a sequence of symbols including respective resources of the subset of the set of resources, refraining from receiving the second sounding reference signal during a first symbol the sequence of symbols based on identifying a gap including the first symbol, and resetting the sequence of indices at a second symbol subsequent to the gap such that the second symbol may be associated with an initial index of the sequence of indices based on the first symbol being within the gap, where receiving the second sounding reference signal includes receiving the second sounding reference signal in the second symbol based on the initial index.

Some examples of the method, apparatuses, and non-transitory computer-readable medium described herein may further include operations, features, means, or instructions for identifying a sequence of indices associated with a sequence of symbols including respective resources of the subset of the set of resources, refraining from receiving the second sounding reference signal during a first symbol the sequence of symbols based on identifying a gap including the first symbol, and deferring an index of the sequence of indices corresponding to the first symbol to a second symbol subsequent to the gap, where receiving the second sounding reference signal includes receiving the second sounding reference signal in the second symbol based on the deferred index.

### BRIEF DESCRIPTION OF THE DRAWINGS

FIG. 1 illustrates an example of a wireless communications system that supports sounding reference signal configuration and activation for partial frequency sounding in accordance with aspects of the present disclosure.

FIG. 2 illustrates an example of a wireless communications system that supports sounding reference signal configuration and activation for partial frequency sounding in accordance with aspects of the present disclosure.

FIGS. 3A, 3B, and 3C illustrate examples of communication gap scenarios that support sounding reference signal configuration and activation for partial frequency sounding in accordance with aspects of the present disclosure.

FIGS. 4A, 4B, and 4C illustrate examples of resource grids that support sounding reference signal configuration and activation for partial frequency sounding in accordance with aspects of the present disclosure.

FIGS. 5A, 5B, and 5C illustrate examples of resource grids that support sounding reference signal configuration and activation for partial frequency sounding in accordance with aspects of the present disclosure.

FIGS. 6A, 6B, and 6C illustrate examples of resource grids that support sounding reference signal configuration and activation for partial frequency sounding in accordance with aspects of the present disclosure.

FIGS. 7A and 7B illustrate examples of resource grids that support sounding reference signal configuration and activation for partial frequency sounding in accordance with aspects of the present disclosure.

FIGS. 8A, 8B, 8C, and 8D illustrate examples of sub-hop counting schemes that support sounding reference signal configuration and activation for partial frequency sounding in accordance with aspects of the present disclosure.

FIGS. 9A and 9B illustrate examples of reconfigurations schemes that support sounding reference signal configuration and activation for partial frequency sounding in accordance with aspects of the present disclosure.

FIGS. 10A, 10B, and 10C illustrate examples of reconfiguration schemes that support sounding reference signal configuration and activation for partial frequency sounding in accordance with aspects of the present disclosure.

FIG. 11 illustrates an example of a process flow that supports sounding reference signal configuration and activation for partial frequency sounding in accordance with aspects of the present disclosure.

FIGS. 12 and 13 show block diagrams of devices that support sounding reference signal configuration and activation for partial frequency sounding in accordance with aspects of the present disclosure.

FIG. 14 shows a block diagram of a communications manager that supports sounding reference signal configuration and activation for partial frequency sounding in accordance with aspects of the present disclosure.

FIG. 15 shows a diagram of a system including a device that supports sounding reference signal configuration and activation for partial frequency sounding in accordance with aspects of the present disclosure.

FIGS. 16 and 17 show block diagrams of devices that support sounding reference signal configuration and activation for partial frequency sounding in accordance with aspects of the present disclosure.

FIG. 18 shows a block diagram of a communications manager that supports sounding reference signal configuration and activation for partial frequency sounding in accordance with aspects of the present disclosure.

FIG. 19 shows a diagram of a system including a device that supports sounding reference signal configuration and activation for partial frequency sounding in accordance with aspects of the present disclosure.

FIGS. 20 through 23 show flowcharts illustrating methods that support sounding reference signal configuration and activation for partial frequency sounding in accordance with aspects of the present disclosure.

### DETAILED DESCRIPTION

A user equipment (UE) may transmit a sounding reference signal (SRS) to a base station to enable the base station to perform channel estimation (e.g., among other functions). In some examples, the base station may transmit, to the UE, a configuration for the sounding reference signal. The configuration may include, for instance, an indication of a set of resources over which the UE may transmit the SRS. In some examples, the SRS may be transmitted over a set of resources that span an entire bandwidth in which sounding is configured. For example, the set of resources may span an entire bandwidth part (BWP), or a substantial number of resource blocks (e.g., 48 resource blocks, 96 resource blocks), and may span substantially more resources than are used in most uplink shared channel transmissions. The set of resources may be divided over multiple symbols into contiguous groups of resources. For instance, a first group of contiguous resources of the set of resources may reside within a first symbol and may span a first portion of the bandwidth and a second group of contiguous resources of the set of resources may reside within a second symbol and may span a second portion of the bandwidth. A pattern of these groups of contiguous resources may be referred to as a hop pattern.

In other examples, the SRS may be transmitted over a subset of the set of resources that may not span the entire configured bandwidth for the SRS. Transmitting the SRS over the subset of the set of resources may be referred to as partial frequency sounding (PFS). In some examples, each group of contiguous resources may have a respective one of the resources in the subset of the set of resources. A pattern of the resources (e.g., a resource pattern) in the subset of the set of resources may be referred to as a PFS pattern.

The present disclosure may describe methods to determine one or more characteristics of a PFS pattern (e.g., a starting position, a sub-hop pattern). Additionally, the present disclosure may describe methods to count and/or allocate sub-hops of a PFS pattern. The present disclosure may also describe methods that a UE may perform if a time gap occurs while the UE is communicating according to the PFS pattern. Further, the present disclosure may describe methods by which the PFS pattern may be reconfigured (e.g., via semi-static control signaling, such as medium access control (MAC) control element (MAC-CE) signaling).

Aspects of the disclosure are initially described in the context of wireless communications systems. Additional aspects of the disclosure are described in the context of communication gap scenarios, resource grids, sub-hop counting schemes, reconfiguration schemes, and a process flow. Aspects of the disclosure are further illustrated by and described with reference to apparatus diagrams, system diagrams, and flowcharts that relate to sounding reference signal configuration and activation for partial frequency sounding.

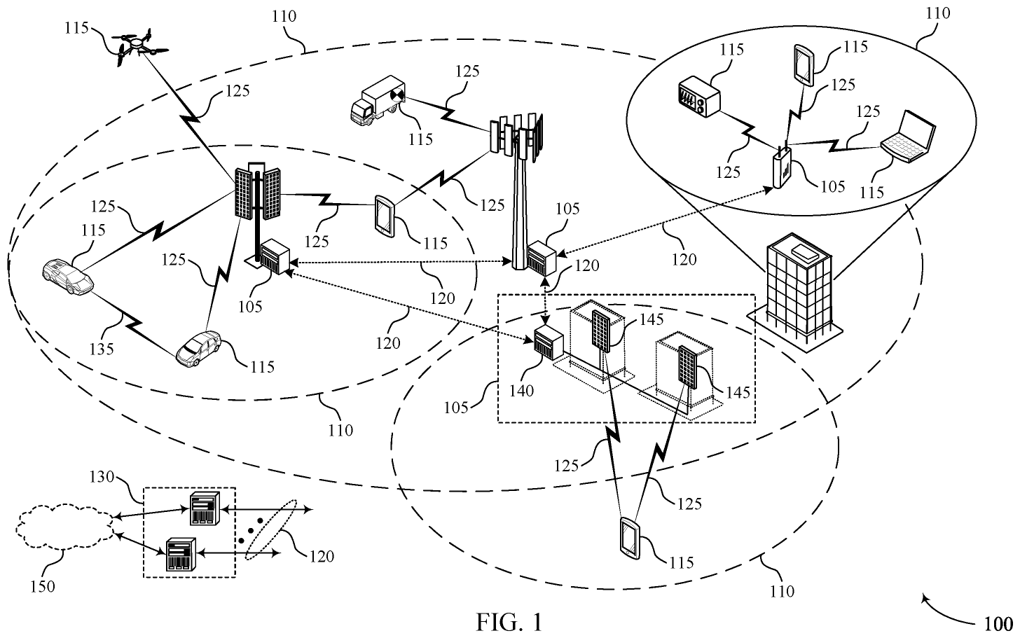

FIG. 1 illustrates an example of a wireless communications system 100 that supports sounding reference signal configuration and activation for partial frequency sounding in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part

of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may transmit an SRS to a base station 105 to enable the base station 105 to perform channel estimation. In some examples, the base station 105 may transmit, to the UE 115, a configuration for the sounding reference signal. The configuration may include, for instance, an indication of a set of resources over which the UE 115 may transmit the SRS. In some examples, the SRS may be transmitted over a set of resources that span an entire BWP, or a substantial amount of resources. The set of resources may be divided over multiple symbols into contiguous groups of resources. For instance, a first group of contiguous resources of the set of resources may reside within a first symbol and may span a first portion of the bandwidth and a second group of contiguous resources of the set of resources may reside within a second symbol and may span a second portion of the bandwidth. A pattern of these groups of contiguous resources may be referred to as a hop pattern.

In other examples, the SRS may be transmitted over a subset of the set of resources that may not span the entire configured bandwidth. Transmitting the SRS over the subset of the set of resources may be referred to as partial frequency sounding (PFS). In some examples, each group of contiguous resources may have a respective one resource in the subset of the set of resources. A pattern of the resources (e.g., a resource pattern) in the subset of the set of resources may be referred to as a PFS pattern.

The present disclosure may describe methods to determine one or more characteristics of a PFS pattern (e.g., a starting position, a sub-hop pattern) Additionally, the present disclosure may describe methods to count and/or allocate sub-hops of a PFS pattern. The present disclosure may also describe methods that a UE 115 may perform if a time gap occurs while the UE 115 is communicating according to the PFS pattern. Further, the present disclosure may describe methods by which the PFS pattern may be reconfigured (e.g., via semi-static control signaling, such as medium access control (MAC) control element (MAC-CE) signaling).

Aspects of the disclosure are initially described in the context of wireless communications systems. Additional aspects of the disclosure are described in the context of communication gap scenarios, resource grids, sub-hop counting schemes, reconfiguration schemes, and a process flow. Aspects of the disclosure are further illustrated by and described with reference to apparatus diagrams, system diagrams, and flowcharts that relate to sounding reference signal configuration and activation for partial frequency sounding.

In some examples, a UE 115 may receive, from a base station 105, control signaling for a first sounding reference signal. The UE 115 may determine, based on the configuration and a set of parameters associated with partial frequency sounding of the first sounding reference signal, a subset of a set of resources configured for the first sounding reference signal, where the subset of the set of resources excludes at least one resource of the set of resources. The UE 115 may transmit, to the base station 105, a second sounding reference signal over the subset of the set of resources.

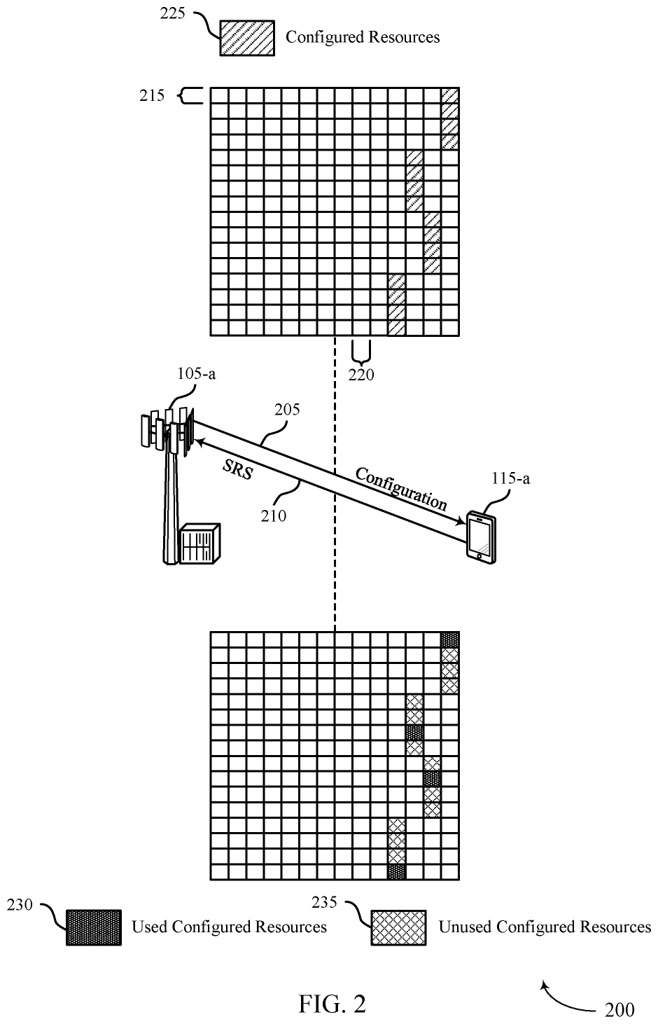

FIG. 2 illustrates an example of a wireless communications system 200 that supports sounding reference signal configuration and activation for partial frequency sounding in accordance with aspects of the present disclosure. In some examples, wireless communications system 200 may be implemented by one or more aspects of wireless communications system 100. For instance, UE 115-a may be an example of a UE 115 as described with reference to FIG. 1 and base station 105-a may be an example of a base station 105 as described with reference to FIG. 1.

Base station 105-a may transmit a configuration to UE 115-a for an SRS. The configuration may indicate, for instance, a bandwidth over which the SRS is to be transmitted and/or a set of resources 225 that span the entire bandwidth. Each resource 225 of the set of resources 225 may span a respective frequency interval 215 (e.g., a subcarrier, a physical resource block (PRB)) and a respective time interval 220 (e.g., a symbol). In some examples, the set of resources 225 may be divided into groups of contiguous resources 225. For instance, in the present example, four of the resources 225 may reside within a first time interval 220 and may form a first group of contiguous resources 225, four of the resources 225 may reside within a second time interval 220 and may form a second group of contiguous resources 225, four of the resources 225 may reside within a third time interval 220 and may form a third group of contiguous resources 225, and four of the resources 225 may reside within a fourth time interval 220 and may form a fourth group of contiguous resources 225. A pattern of the groups of contiguous resources may be referred to as a hop pattern.

UE 115-a may determine, based on the configuration and a set of parameters associated with PFS, a subset of the set of resources 225, where the subset of the set of resources 225 excludes at least one resource 225 of the set of resources 225. For instance, the subset of the set of resources 225 may include used resources 230 and may exclude unused resources 235. In some examples, each group of contiguous resources 225 may include one used resource 230 and the remaining resources 225 of the group may be unused resources 235. A pattern of the used resources 230 may be referred to as a PFS pattern and the position of the used resources 230 may be determined according to a sub-hop pattern.

UE 115-a may transmit an SRS 210 to base station 105-a over the used resources 230 and may refrain from transmitting the SRS 210 over the unused resources 235. Base station 105-a may use the SRS 210 to perform channel estimation.

In some examples, hopping selection for a frequency hopping pattern may be determined based on a parameter n_{SRS}. In some examples

$${n}_{SRS} = ( \frac{{N}_{slot}^{frame , μ} + {n}_{s , f}^{μ} - {T}_{offset}}{{T}_{SRS}} ) ( \frac{{N}_{symb}^{SRS}}{R} ) + ⌊ \frac{l ′}{R} ⌋ , \text{} where ( {N}_{slot}^{frame , μ} + {n}_{s , f}^{μ} - {T}_{offset} ) mod ( {T}_{SRS} ) = 0 ,$$

and where Nₛₗₒₜ^{frame,μ} corresponds to a number of slots per frame for a subcarrier spacing configuration μ; n_{f} is a system frame number (SFN); n_{s,f}^{μ} is a slot number within a frame for a subcarrier spacing configuration μ; T_{offset} is a slot offset; T_{SRS} is a periodicity; N_{symb}^{SRS} corresponds to a number of consecutive OFDM symbols; l′ is a symbol number within a slot; and R is a repetition factor.

In some examples, wireless communications systems 200 that support PFS may support transmission of SRS 210 in

$$\frac{1}{{P}_{F}} {m}_{SRS , {B}_{SRS}}$$

OFDM symbol, where m_{SRS,B}_{_{SRS}} indicates the number of resource blocks configured by B_{SRS} and C_{SRS}. Additionally, such wireless communications systems 200 may support at least one P_{F} from {2, [3], 4, 8} or other candidate values (e.g., non-integer values).

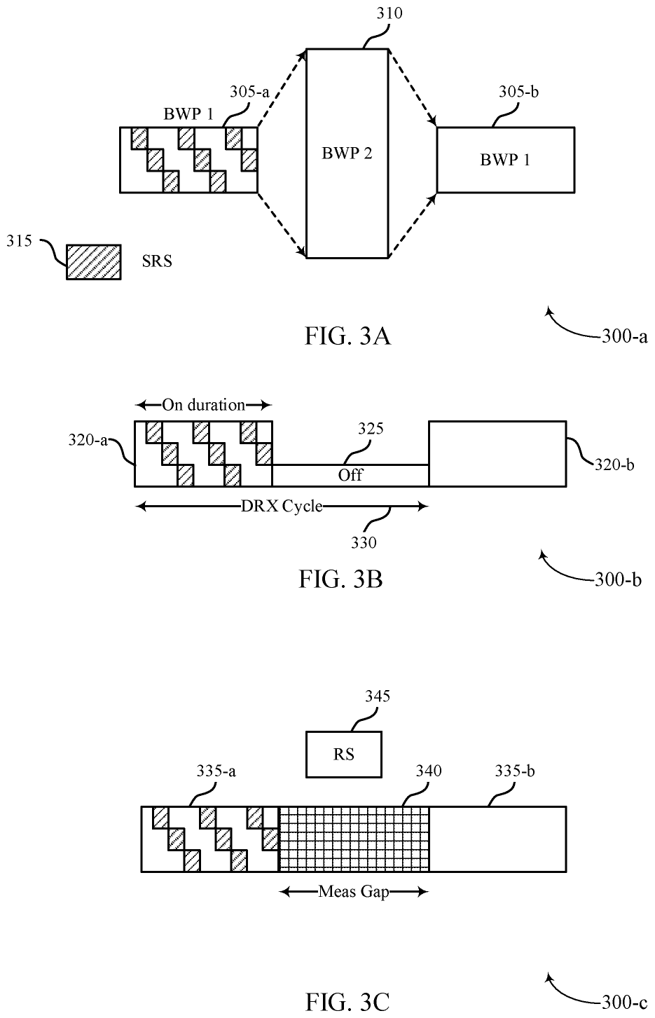

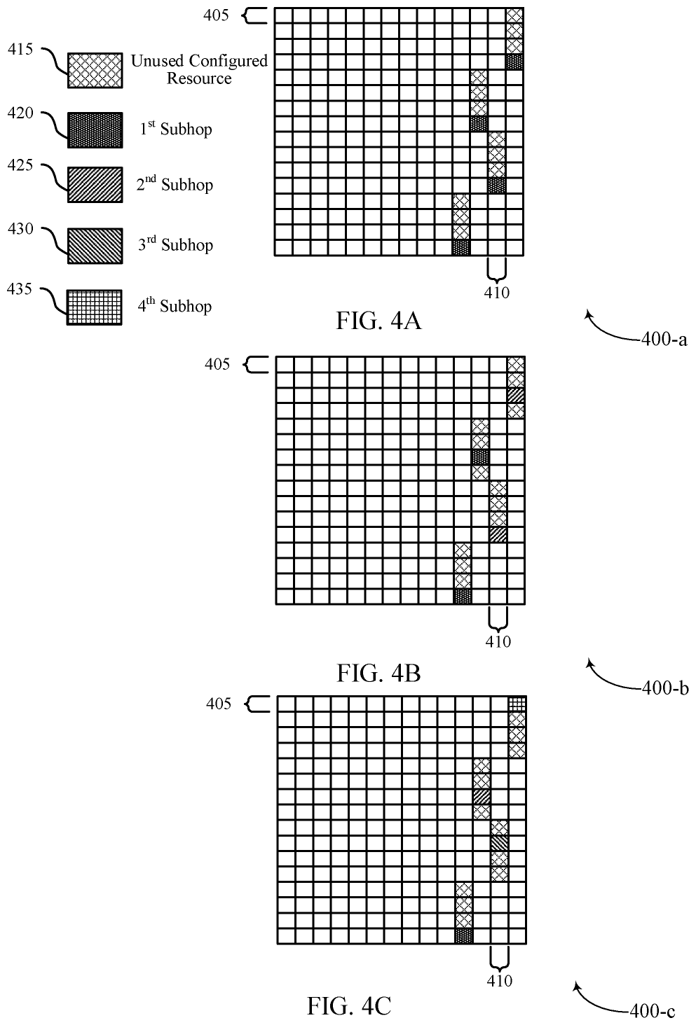

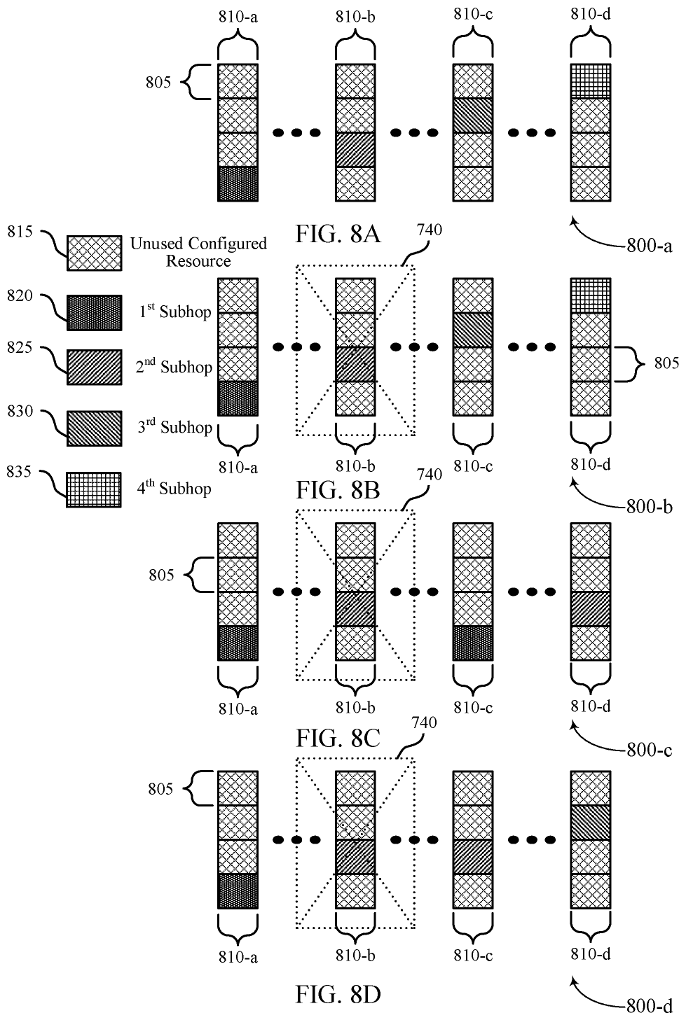

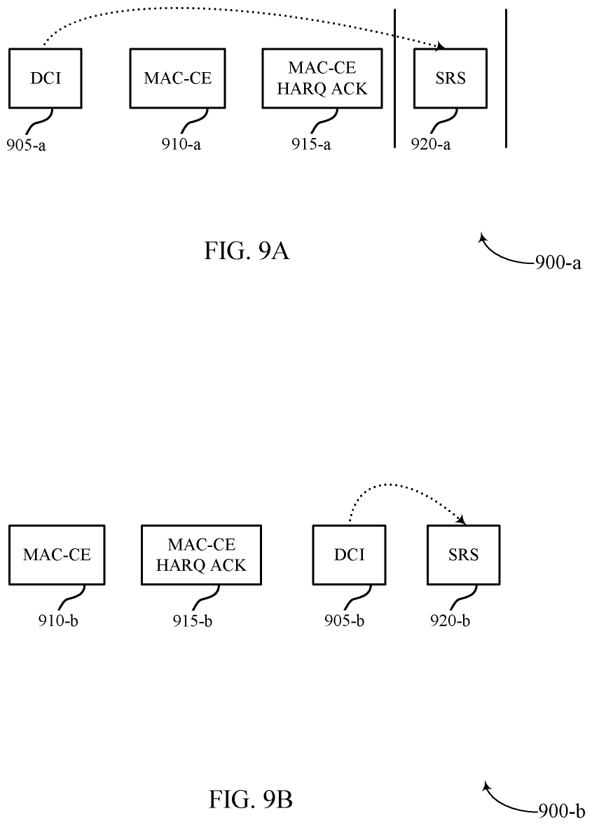

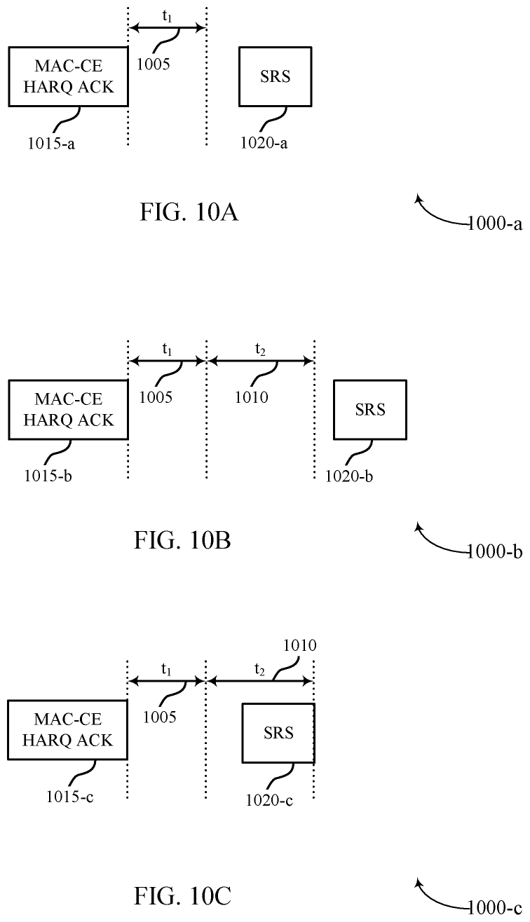

The methods described herein may describe how to perform PFS frequency hopping pattern counting (e.g., how to count PFS hopping), for instance, with regards to FIGS. 4A through 7B. Additionally, the methods described herein may describe behavior for UE 115-a when an intervening time gap is present. For instance, when UE 115-a is activated with PFS for periodic and/or semi-periodic SRS resource sets at specific bandwidth parts and an intervening time gap occurs, the methods described herein may describe whether UE 115-a may resume PFS and how UE 115-a may do so. The intervening time gap may include BWP switching to and then switching back to a same BWP, a discontinuous reception (DRX) cycle (e.g., an off duration and then back to an on duration), a measurement gap outside of BWP frequency resources or a collision with other signals and/or channels. Additional details about scenarios in which timing gaps occur may be described with reference to FIGS. 3A through 3C. Additional details about UE behavior when time gaps occur may be described with reference to FIGS. 8A through 8D. The methods herein may also describe MAC-CE reconfiguration and UE behavior when receiving a MAC-CE reconfiguration. Additional details about MAC-CE reconfiguration may be described herein, for instance, with reference to FIGS. 9A through 10C.

In some examples, a frequency-domain starting position and a sub-hop pattern may be determined according to k₀^{(p}^{ᵢ}⁾=k̅₀^{(p}^{ᵢ}⁾+Σ_{b=0}^{B}^{_{SRS}}K_{TC}M_{sc,b}^{SRS}n_{b}+f(P_{F}, K_{TC}, M_{sc,B}_{_{SRS}}^{SRS}), where M_{sc,b}^{SRS}=m_{srs,b}N_{SC}^{RB}/K_{TC}. In some examples, a parameter n_{PFS}^{shift} may control a sub-hop first index and a function G(n_{PFS}) may control a sub-hop pattern changed with n_{PFS}, where n_{PFS} may be a count of symbols. In some such examples,

$$f ( {P}_{F} , {K}_{TC} , {M}_{sc , {B}_{SRS}}^{SRS} ) = ( \frac{{K}_{TC} {M}_{sc , {B}_{SRS}}^{SRS}}{{P}_{F}} ) [ ( G ( {n}_{PFS} ) + {n}_{PFS}^{shift} ) mod {P}_{F} ] .$$

Additionally, in some such examples, G(n_{PFS}) may be equal 0 if PFS sub-hopping is disabled and may equal F (n_{PFS}) if PFS sub-hopping is enabled, where F(n_{PFS}) may equal n_{PFS}, another function, or may be derived from a predefined table. In some examples, n_{PFS}^{shift} may be used to determine a sub-hop first index and may, for instance, be conveyed via radio resource control (RRC) signaling. In some examples, to enable controlling of PFS sub-hopping, a new parameter may be introduced (e.g., bₕₒₚ^{PFS}) or an SRS hopping triggering condition may be used (e.g., bₕₒₚ may be reused).

In some examples, (P_{F}, K_{TC}, M_{sc,B}_{_{SRS}}^{SRS}) may be set such that (P_{F}, K_{TC}, M_{sc,B}_{_{SRS}}^{SRS})=Σᵢ₌₀^{B}^{_{PFS}}K_{TC}M_{sc,B}_{_{SRS}}^{SRS}nᵢ, where bₕₒₚ^{PFS} and \hat{n}_{RRC} may control the sub-hop pattern. In some such examples, M_{sc,B}_{_{SRS}}^{SRS}=m_{SRS,i}N_{SC}^{RB} and

$${m}_{SRS , i} = {m}_{SRS , {B}_{SRS}} \frac{{\prod }_{\hat{ι} = 0}^{i} {N}_{\hat{ι}}}{{P}_{F}} .$$

In some examples, bₕₒₚ^{PFS} may be used to control the PFS sub-hop enabling and pattern. If bₕₒₚ^{PFS}>B_{PFS}, the sub-hopping may be disabled and nᵢ may remain constant, given by nᵢ=L_{RRC}modNᵢ. If bₕₒₚ^{PFS}<B_{PFS}, then sub-hopping may be enabled and nᵢ may change with n_{PFS}. In some examples, nᵢ may equal L_{RRC}modNᵢ for i≤bₕₒₚ^{PFS} and may equal (Fᵢ(n_{PFS})+L_{RRC})modNᵢ otherwise. In some examples,

$${L}_{RRC} = [ \frac{4 {\hat{n}}_{RRC}}{{m}_{SRS , i}^{PFS}} ]$$

and \hat{n}_{RRC} may be a unique parameter n_{RRC} may be used. In some examples, Fᵢ(n_{PFS}) may use F_{b}(n_{PFS}), where b, bₕₒₚ is substituted with i, bₕₒₚ^{PFS} and n_{SRS} is substituted with n_{PFS}. In some examples,

$${F}_{b} ( {n}_{PFS} ) = ( \frac{{N}_{b}}{2} ) ⌊ \frac{{n}_{SRS} mod {\prod }_{{b}^{′} = {b}_{hop}}^{b} {N}_{b ′}}{{\prod }_{{b}^{′} = {b}_{hop}}^{b - 1} {N}_{b ′}} ⌋ + ⌊ \frac{{n}_{SRS} mod {\prod }_{{b}^{′} = {b}_{hop}}^{b} {N}_{b ′}}{2 {\prod }_{{b}^{′} = {b}_{hop}}^{b - 1} {N}_{b ′}} ⌋$$

if N_{b} is even and may be equal to

$$⌊ \frac{{N}_{b}}{2} ⌋ ⌊ \frac{{n}_{SRS}}{{\prod }_{{b}^{′} = {b}_{hop}}^{b - 1} {N}_{b ′}} ⌋$$

if N_{b} is odd.

In some examples, a table may provide a relationship between P_{F}, B_{PFS} and Nᵢ(i=0, . . . , B_{PFS}). The entries of the table may be in a configuration that satisfies P_{F}=Πᵢ₌₀^{B}^{_{PFS}}Nᵢ. For example, B_{PFS}=log₂P_{F}. An example of the table may be provided below:

| P_{F} | B_{PFS} | N₀ | N₁ | N₂ | N₃ |
|---|---|---|---|---|---|
| 1 | 0 | 1 | \ | \ | \ |
| 2 | 1 | 1 | 2 | \ | \ |
| 4 | 2 | 1 | 2 | 2 | \ |
| 8 | 3 | 1 | 2 | 2 | 2 |

The present disclosure may describe methods to count and/or allocate sub-hops. For instance, the sub-hops may be counted and/or allocated based on a symbol or slot number. A pre-defined pattern may be used for each hop. In some examples, the hopping pattern and/or sub-hop index selection may be based on n_{SRS} or n_{PFS}. In some examples,

$${n}_{srs} = ( \frac{{N}_{slot}^{frame , μ} + {n}_{s , f}^{μ} - {T}_{offset}}{{T}_{SRS}} ) ( \frac{{N}_{symb}^{SRS}}{R} ) + ⌊ \frac{{l}^{′}}{R} ⌋ , \\ where ( {N}_{slot}^{frame , μ} + {n}_{s , f}^{μ} - {T}_{offset} ) mod ( {T}_{SRS} ) = 0.$$

In some examples, l′ may correspond to a symbol within the set of resources configured for transmitting an SRS. In some examples, n_{PFS} may be the same for different symbols within one SRS resource hop or may be different for different symbols. For instance, in examples in which n_{PFS} is the same within one SRS resource, n_{PFS} may be equal to an offset combined with a symbol number divided by a total number of symbols

$$( e . g . , {n}_{P F S} = {n}_{P F S Offset} + ⌊ \frac{{l}^{′}}{{N}_{s y m b}^{SRS}} ⌋ ) .$$

In examples in which n_{PFS} is the same within one SRS resource hop, n_{PFS} may be equal to an offset combined with a symbol number divided by a repetition parameter (e.g., a repetition parameter applied for full-frequency sounding) rounded down

$$( e . g . , {n}_{P F S} = {n}_{P FSOffset} + ⌊ \frac{{l}^{′}}{R} ⌋ ) .$$

In examples in which n_{PFS} is different for different symbols, n_{PFS} may be equal to an offset combined with a symbol number (e.g., n_{PFS}=n_{PFSOffest}+l′). In examples in which n_{PFS} is the same within PFS repetition (e.g., and different or the same with SRS repetition, different for different repetition), n_{PFS} may be equal to an offset combined with a symbol number divided by a PFS-specific repetition parameter rounded down

$$( e . g . , {n}_{P F S} = {n}_{P FSOffset} + ⌊ \frac{{l}^{′}}{{R}^{′}} ⌋ ) .$$

In some examples, n_{PFSOffest} may be inversely proportional to a repetition parameter applied for full-frequency sounding

$$( e . g . , {n}_{PFSOffset} = ( \frac{{N}_{slot}^{frame , μ} + {n}_{s , f}^{μ} - {T}_{offset}}{{T}_{SRS}} ) ( \frac{{N}_{symb}^{SRS}}{R} ) ) .$$

or may be inversely proportional to a repetition parameter specific to partial-frequency sounding

$$( e . g . , {n}_{PFSOffset} = ( \frac{{N}_{slot}^{frame , μ} + {n}_{s , f}^{μ} - {T}_{offset}}{{T}_{SRS}} ) ( \frac{{N}_{symb}^{SRS}}{{R}^{′}} ) ) .$$

In some examples, n_{PFSOffest} may be reset to 0 for each SRS resource, may be set to 0 for each SRS resource hop, may be reset to 0 for a number of SRS symbols, or any combination thereof. For instance, n_{PFSOffest} may be equal to

$$( \frac{{N}_{slot}^{frame , μ} + {n}_{s , f}^{μ} - {T}_{offset}}{{T}_{SRS}} ) ( \frac{{N}_{symb}^{SRS}}{R} ) or ( \frac{{N}_{slot}^{frame , μ} + {n}_{s , f}^{μ} - {T}_{offset}}{{T}_{SRS}} ) ( \frac{{N}_{symb}^{SRS}}{{R}^{′}} )$$

for a first set of SRS resources, SRS resource hops, or SRS symbols, but may be reset to 0 for a second set of SRS resources, SRS resource hops, or SRS symbols following the first set. Additionally, n_{PFSOffest} may be set back to

$$( \frac{{N}_{slot}^{frame , μ} + {n}_{s , f}^{μ} - {T}_{offset}}{{T}_{SRS}} ) ( \frac{{N}_{symb}^{SRS}}{R} ) or ( \frac{{N}_{slot}^{frame , μ} + {n}_{s , f}^{μ} - {T}_{offset}}{{T}_{SRS}} ) ( \frac{{N}_{symb}^{SRS}}{{R}^{′}} )$$

for a third set of SRS resources, SRS resource hops, or SRS symbols following the second set. Additional details may be described with reference to FIGS. 4A through 7B.

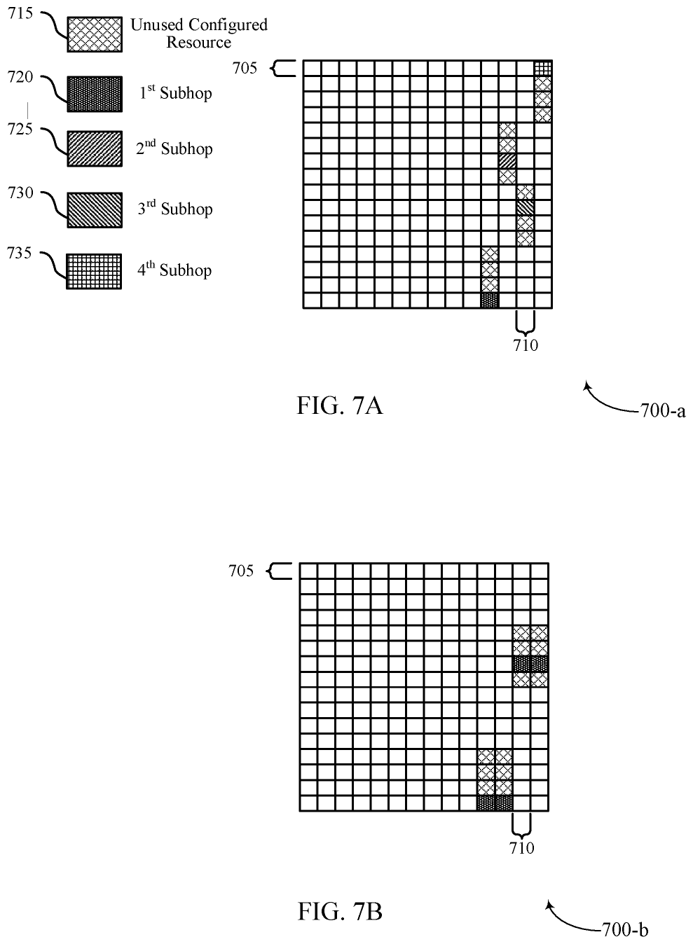

The present disclosure may describe a mapping between counting and sub-index mapping. For instance, the sub-index may be the same as counting (e.g., as illustrated with reference to FIG. 7A). Additionally or alternatively, a sub-index list for each hop may be predefined. The sub-index used may be according to a counting number. For instance, the first hop may be defined according to {0,1,2,3} and the second hop may be defined according to {1,2,3,0}. An example may be illustrated with reference to FIG. 7B.

The present disclosure may describe partial frequency sounding behavior. For instance, in some examples, UE 115-a may determine that PFS is deactivated if a measurement gap is larger than a certain threshold, if BWP switching happens, or both. If neither one of these conditions occur, UE 115-a may determine that PFS is still active after the gap. If PFS is deactivated, the UE 115-a may fall back to sending SRS without PFS and may send SRS without PFS until PFS is reactivated.

In some examples, PFS may be resumed after an intervening time gap. In some such examples, UE 115-a may reset the pattern (e.g., starts from an indicated sub-hop pattern) or may resume the pattern based on the length of the intervening time gap.

For instance, counting may be resumed based on a symbol or slot number (e.g., as illustrated in FIG. 8B). Alternatively, UE 115-a may reset the pattern (e.g., may start from an indicated sub-hop pattern or a pre-defined pattern), which may be illustrated in FIG. 8C. Alternatively, UE 115-a may resume from a last count number (e.g., as illustrated in FIG. 8D). In some such examples, the symbols and/or slots during BWP switching, a DRX cycle, or a measurement gap may not be treated as valid symbols and/or slots by UE 115-a.

The present disclosure may describe methods for MAC-CE reconfiguration. For instance, a MAC-CE may reconfigure the pattern and/or index of sub-hops separately or together with other reconfiguration parameters (e.g., SRS resource parameters and/or SRS resource set parameters). An example may be illustrated with reference to FIG. 9A.

The present disclosure may describe methods for resuming counting from a MAC-CE reconfiguration. For instance, before a MAC-CE becomes valid (e.g., 3 milliseconds), no change on counting or a sub-hop pattern may occur. However, after MAC-CE is valid and new downlink control information (DCI) is received by UE 115-a (e.g., from base station 105-a), sub-hopping may follow a MAC-CE indication. If the MAC-CE indicates a new pattern and/or sub-hop index, UE 115-a may use the new pattern and/or sub-hop index. However, if the MAC-CE does not include the sub-hop related information, no change may occur for the counting and/or the sub-hop pattern. An example may be illustrated with reference to FIG. 9B.

In some examples, MAC-CE reconfiguration may occur before the MAC-CE is valid. In some examples, as long as the MAC-CE is valid (e.g., it has been greater than 3 milliseconds since the MAC-CE was received), the SRS settings may change. After the MAC-CE is valid, an additional gap may occur for SRS setting changes. After this additional gap, the SRS settings may change. If SRS is transmitted within this additional gap, any sub-hop related changes within the MAC-CE may be ignored or not used. Alternatively, a predefined pattern may be used (e.g., where the pattern is reset).

In some examples, the methods described herein may be associated with one or more advantages. For instance, the methods described herein may define a sub-hop pattern that enables UE 115-a to transmit an SRS 210 over a fewer number of resources as compared to SRSs that are transmitted over a full bandwidth. Additionally, receiving a MAC-CE that reconfigures the sub-hop pattern and determining whether or not to continue transmitting PFS SRSs 210 following a gap may enable UE 115-a to adapt to changing conditions at or around UE 115-a.

FIGS. 3A, 3B and 3C illustrate examples of communication gap scenarios 300-a, 300-b, and 300-c that support sounding reference signal configuration and activation for partial frequency sounding in accordance with aspects of the present disclosure. In some examples, communication gap scenarios 300-a, 300-b, and 300-c may represent scenarios in which an intervening gap occurs.

FIG. 3A may illustrate an example of a gap occurring due to BWP switching. Initially, a UE 115 may communicate within BWP 305. In some examples, UE 115 may switch from communicating within BWP 305 to communicating within BWP 310. SRS resources 315 may be configured within BWP 305, but may not be configured within BWP 310. Accordingly, a gap in transmitting over SRS resources 315 may occur at least until the UE 115 switches back to BWP 305.

FIG. 3B may illustrate an example of a gap occurring due to a UE 115 operating according to a DRX cycle. Initially, the UE 115 may be active during an on duration 320-a. However, the UE 115 may switch to being idle or inactive during an off duration 325. During the off duration 325, the UE 115 may be incapable of transmitting over SRS resources 315, whereas the UE 115 may be capable of transmitting over SRS resources 315 during the on duration 320-a. Additionally, after the off-duration 325, the UE 115 may enter another on-duration 320-b. Accordingly, off-duration 325 may represent a gap in transmitting over SRS resources 325.

FIG. 3C may illustrate a gap occurring due to a UE 115 employing a measurement gap. Initially, the UE may be transmitting during interval 335-a. However, the UE 115 may begin receiving measuring for reference signals 345 during a measurement gap 340. While measuring for reference signals 345, the UE may be incapable of transmitting over SRS resources 315, whereas the UE 115 may be capable of transmitting over SRS resources 315 during interval 335-a. Additionally, after the measurement gap 340, the UE 115 may enter another interval 335-a in which the UE 115 may transmit over SRS resources 315. Accordingly, measurement gap 340 may represent a gap in transmitting over SRS resources 325.

FIGS. 4A, 4B, and 4C illustrate examples of resource grids 400-a, 400-b, and 400-c that support sounding reference signal configuration and activation for partial frequency sounding in accordance with aspects of the present disclosure. Resource grids 400-a, 400-b, and 400-c may represent a grid of resources when N_{symb}^{SRS}=4 and R=1.

Resource grid 400-a may be an example of a grid of resources with

$$⌊ \frac{{l}^{′}}{4} ⌋ .$$

Resource grid 400-a may include a set of configured resources, where each resource spans a frequency interval 405 (e.g., subcarrier, PRB) and a symbol 410. The set of resources may be divided among symbols 410 into groups of contiguous resources. For instance, in the present example, four resources may reside within a first symbol 410 and form a first group; four resources may reside within a second symbol 410 and form a second group; four resources may reside within a third symbol 410 and form a third group; and four resources may reside within a fourth symbol 410 and form a fourth group. For PFS, one resource from each group may be used to transmit an SRS and each other resource may be an unused resource 415. In the present example, for

$$⌊ \frac{{l}^{′}}{4} ⌋ ,$$

each of the used resources may be first sub-hop resources 420 (e.g., resources associated with a first sub-hop).

Resource grid 400-b may be an example of a grid of resources with

$$⌊ \frac{{l}^{′}}{2} ⌋ .$$

Resource grid 400-b may include a set of configured resources, where each resource spans a frequency interval 405 (e.g., subcarrier, PRB) and a symbol 410. The set of resources may be divided among symbols 410 into groups of contiguous resources. For instance, in the present example, four resources may reside within a first symbol 410 and form a first group; four resources may reside within a second symbol 410 and form a second group; four resources may reside within a third symbol 410 and form a third group; and four resources may reside within a fourth symbol 410 and form a fourth group. For PFS, one resource from each group may be used to transmit an SRS and each other resource may be an unused resource 415. In the present example, for

$$⌊ \frac{{l}^{′}}{2} ⌋ ,$$

two of the used resources may be first sub-hop resources 420 (e.g., resources associated with a first sub-hop) and two of the used resources may be second sub-hop resources 425.

Resource grid 400-c may be an example of a grid of resources with

$$⌊ \frac{{l}^{′}}{1} ⌋ .$$

Resource grid 400-c may include a set of configured resources, where each resource spans a frequency interval 405 (e.g., subcarrier, PRB) and a symbol 410. The set of resources may be divided among symbols 410 into groups of contiguous resources. For instance, in the present example, four resources may reside within a first symbol 410 and form a first group; four resources may reside within a second symbol 410 and form a second group; four resources may reside within a third symbol 410 and form a third group; and four resources may reside within a fourth symbol 410 and form a fourth group. For PFS, one resource from each group may be used to transmit an SRS and each other resource may be an unused resource 415. In the present example, for

$$⌊ \frac{{l}^{′}}{1} ⌋ ,$$

one of the used resources may be a first sub-hop resource 420 (e.g., a resource associated with a first sub-hop); one of the used resource may be a second sub-hop resource 425 (e.g., a resource associated with a second sub-hop); one of the used resource may be a third sub-hop resource 430 (e.g., a resource associated with a third sub-hop); one of the used resource may be a fourth sub-hop resource 435 (e.g., a resource associated with a fourth sub-hop).

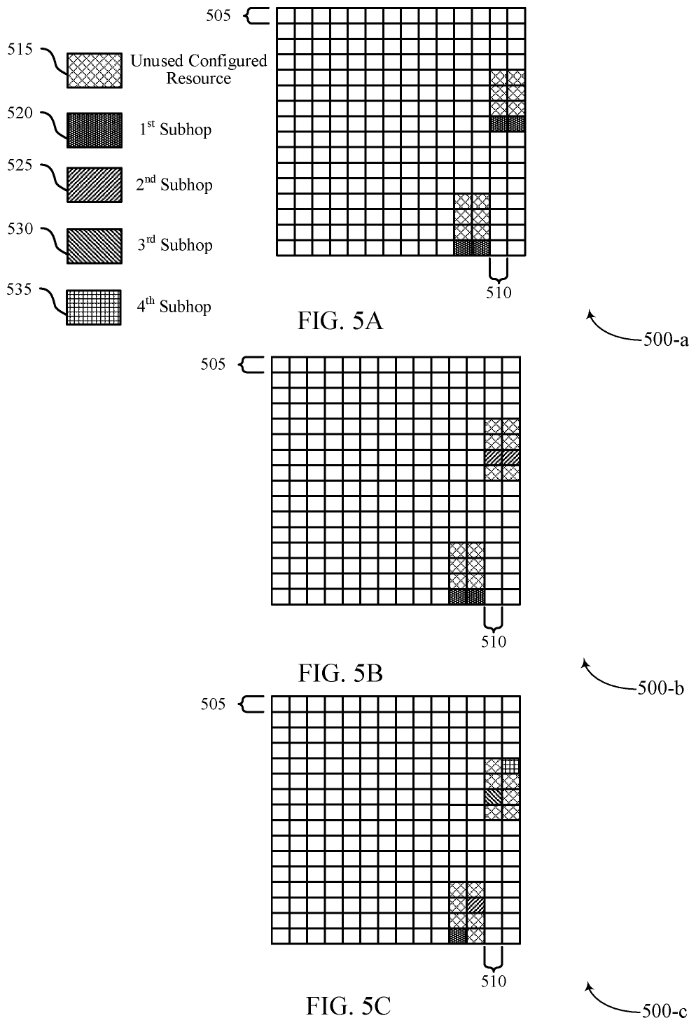

FIGS. 5A, 5B, and 5C illustrate examples of resource grids 500-a, 500-b, and 500-c that support sounding reference signal configuration and activation for partial frequency sounding in accordance with aspects of the present disclosure. Resource grids 500-a, 500-b, and 500-c may represent a grid of resources when N_{symb}^{SRS}=4 and R=2.

Resource grid 500-a may be an example of a grid of resources with

$$⌊ \frac{{l}^{′}}{4} ⌋ .$$

Resource grid 500-a may include a set of configured resources, where each resource spans a frequency interval 505 (e.g., subcarrier, PRB) and a symbol 510. The set of resources may be divided among symbols 510 into groups of contiguous resources. For instance, in the present example, four resources may reside within a first symbol 510 and form a first group; four resources may reside within a second symbol 510 and form a second group; four resources may reside within a third symbol 510 and form a third group; and four resources may reside within a fourth symbol 510 and form a fourth group. For PFS, one resource from each group may be used to transmit an SRS and each other resource may be an unused resource 515. In the present example, for

$$⌊ \frac{l ′}{4} ⌋ ,$$

each of the used resources may be first sub-hop resources 520 (e.g., resources associated with a first sub-hop).

Resource grid 500-b may be an example of a grid of resources with

$$⌊ \frac{l ′}{2} ⌋ .$$

Resource grid 500-b may include a set of configured resources, where each resource spans a frequency interval 505 (e.g., subcarrier, PRB) and a symbol 510. The set of resources may be divided among symbols 510 into groups of contiguous resources. For instance, in the present example, four resources may reside within a first symbol 510 and form a first group; four resources may reside within a second symbol 510 and form a second group; four resources may reside within a third symbol 510 and form a third group; and four resources may reside within a fourth symbol 510 and form a fourth group. For PFS, one resource from each group may be used to transmit an SRS and each other resource may be an unused resource 515. In the present example, for

$$⌊ \frac{l ′}{2} ⌋ ,$$

two of the used resources may be first sub-hop resources 520 (e.g., resources associated with a first sub-hop) and two of the used resources may be second sub-hop resources 525.

Resource grid 500-c may be an example of a grid of resources with

$$⌊ \frac{l ′}{1} ⌋ .$$

Resource grid 500-c may include a set of configured resources, where each resource spans a frequency interval 505 (e.g., subcarrier, PRB) and a symbol 510. The set of resources may be divided among symbols 510 into groups of contiguous resources. For instance, in the present example, four resources may reside within a first symbol 510 and form a first group; four resources may reside within a second symbol 510 and form a second group; four resources may reside within a third symbol 510 and form a third group; and four resources may reside within a fourth symbol 510 and form a fourth group. For PFS, one resource from each group may be used to transmit an SRS and each other resource may be an unused resource 515. In the present example, for

$$⌊ \frac{l ′}{1} ⌋ ,$$

one of the used resources may be a first sub-hop resource 520 (e.g., a resource associated with a first sub-hop); one of the used resource may be a second sub-hop resource 525 (e.g., a resource associated with a second sub-hop); one of the used resource may be a third sub-hop resource 530 (e.g., a resource associated with a third sub-hop); one of the used resource may be a fourth sub-hop resource 535 (e.g., a resource associated with a fourth sub-hop).

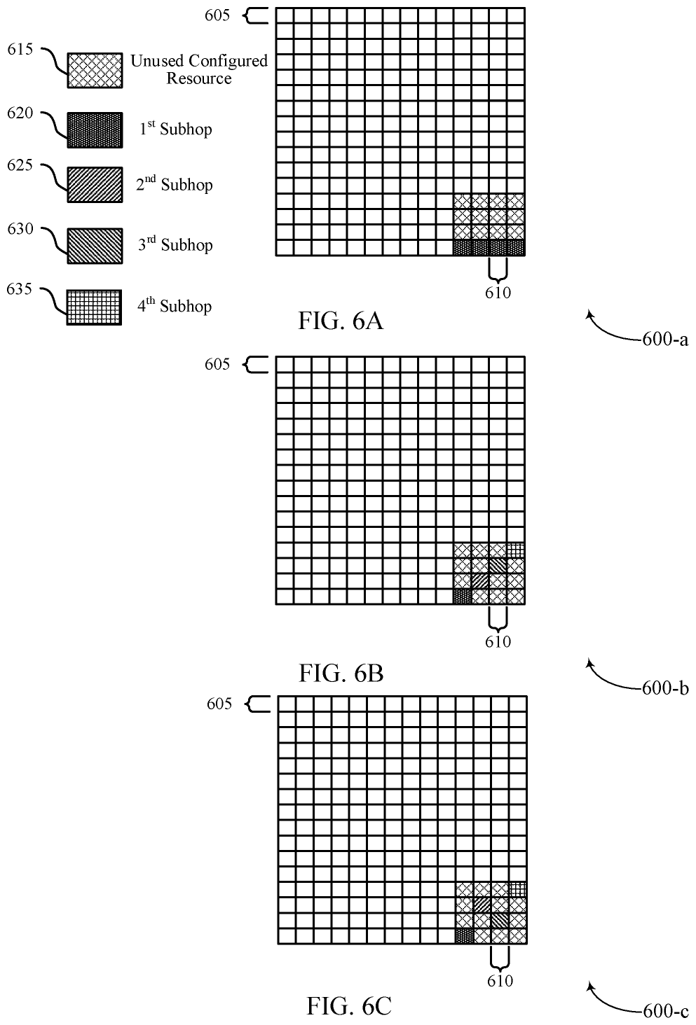

FIGS. 6A, 6B, and 6C illustrate examples of resource grids 600-a, 600-b, and 600-c that support sounding reference signal configuration and activation for partial frequency sounding in accordance with aspects of the present disclosure. Resource grids 600-a, 600-b, and 600-c may represent a grid of resources when N_{symb}^{SRS}=4 and R=4.

Resource grid 600-a may be an example of a grid of resources with

$$⌊ \frac{l ′}{4} ⌋ .$$

Resource grid 600-a may include a set of configured resources, where each resource spans a frequency interval 605 (e.g., subcarrier, PRB) and a symbol 610. The set of resources may be divided among symbols 610 into groups of contiguous resources. For instance, in the present example, four resources may reside within a first symbol 610 and form a first group; four resources may reside within a second symbol 610 and form a second group; four resources may reside within a third symbol 610 and form a third group; and four resources may reside within a fourth symbol 610 and form a fourth group. For PFS, one resource from each group may be used to transmit an SRS and each other resource may be an unused resource 615. In the present example, for

$$⌊ \frac{l ′}{4} ⌋ ,$$

each of the used resources may be first sub-hop resources 620 (e.g., resources associated with a first sub-hop).

Resource grid 600-b may be an example of a grid of resources with

$$⌊ \frac{l ′}{2} ⌋ .$$

Resource grid 600-b may include a set of configured resources, where each resource spans a frequency interval 605 (e.g., subcarrier, PRB) and a symbol 610. The set of resources may be divided among symbols 610 into groups of contiguous resources. For instance, in the present example, four resources may reside within a first symbol 610 and form a first group; four resources may reside within a second symbol 610 and form a second group; four resources may reside within a third symbol 610 and form a third group; and four resources may reside within a fourth symbol 610 and form a fourth group. For PFS, one resource from each group may be used to transmit an SRS and each other resource may be an unused resource 615. In the present example, for

$$⌊ \frac{l ′}{2} ⌋ ,$$

two of the used resources may be first sub-hop resources 620 (e.g., resources associated with a first sub-hop) and two of the used resources may be second sub-hop resources 625.

Resource grid 600-c may be an example of a grid of resources with

$$⌊ \frac{l ′}{1} ⌋ .$$

Resource grid 600-c may include a set of configured resources, where each resource spans a frequency interval 605 (e.g., subcarrier, PRB) and a symbol 610. The set of resources may be divided among symbols 610 into groups of contiguous resources. For instance, in the present example, four resources may reside within a first symbol 610 and form a first group; four resources may reside within a second symbol 610 and form a second group; four resources may reside within a third symbol 610 and form a third group; and four resources may reside within a fourth symbol 610 and form a fourth group. For PFS, one resource from each group may be used to transmit an SRS and each other resource may be an unused resource 615. In the present example, for

$$⌊ \frac{l ′}{1} ⌋ ,$$

one of the used resources may be a first sub-hop resource 620 (e.g., a resource associated with a first sub-hop); one of the used resource may be a second sub-hop resource 625 (e.g., a resource associated with a second sub-hop); one of the used resource may be a third sub-hop resource 630 (e.g., a resource associated with a third sub-hop); one of the used resource may be a fourth sub-hop resource 635 (e.g., a resource associated with a fourth sub-hop).

FIGS. 7A and 7B illustrate examples of resource grids 700-a and 700-b that supports sounding reference signal configuration and activation for partial frequency sounding in accordance with aspects of the present disclosure. Resource grids 700-a and 700-b may represent grids of resources for different counting schemes.

Resource grid 700-c may be an example of a grid of resources with

$$⌊ \frac{l ′}{1} ⌋$$

and R=1. Resource grid 700-c may include a set of configured resources, where each resource spans a frequency interval 705 (e.g., subcarrier, PRB) and a symbol 710. The set of resources may be divided among symbols 710 into groups of contiguous resources. For instance, in the present example, four resources may reside within a first symbol 710 and form a first group; four resources may reside within a second symbol 710 and form a second group; four resources may reside within a third symbol 710 and form a third group; and four resources may reside within a fourth symbol 710 and form a fourth group. For PFS, one resource from each group may be used to transmit an SRS and each other resource may be an unused resource 715. In the present example, for

$$⌊ \frac{l ′}{1} ⌋ ,$$

one of the used resources may be a first sub-hop resource 720 (e.g., a resource associated with a first sub-hop); one of the used resource may be a second sub-hop resource 725 (e.g., a resource associated with a second sub-hop); one of the used resource may be a third sub-hop resource 730 (e.g., a resource associated with a third sub-hop); one of the used resource may be a fourth sub-hop resource 735 (e.g., a resource associated with a fourth sub-hop). In some examples, resource grid 700-a may be an example in which the sub-index matches counting.

Resource grid 700-b may be an example of a grid of resources with

$$⌊ \frac{l ′}{4} ⌋$$

and R=2. Resource grid 700-b may include a set of configured resources, where each resource spans a frequency interval 705 (e.g., subcarrier, PRB) and a symbol 710. The set of resources may be divided among symbols 710 into groups of contiguous resources. For instance, in the present example, four resources may reside within a first symbol 710 and form a first group; four resources may reside within a second symbol 710 and form a second group; four resources may reside within a third symbol 710 and form a third group; and four resources may reside within a fourth symbol 710 and form a fourth group. For PFS, one resource from each group may be used to transmit an SRS and each other resource may be an unused resource 715. In the present example, for

$$⌊ \frac{l ′}{4} ⌋ ,$$

each of the used resources may be first sub-hop resources 720 (e.g., resources associated with a first sub-hop). In some examples, resource grid 700-b may be an example in which a sub-index list is predefined or a sub-index is used according to a counting number.

FIGS. 8A, 8B, 8C, and 8D illustrate examples of sub-hop counting schemes 800-a, 800-b, 800-c, and 800-d that supports sounding reference signal configuration and activation for partial frequency sounding in accordance with aspects of the present disclosure. Sub-hop counting schemes 800-a, 800-b, 800-c, and 800-d may depict how sub-hop counting may occur after an intervening gap.

FIG. 8A may include symbols 810-a, 810-b, 810-c, and 810-d, which may be examples of symbols. Each symbol 810-a, 810-b, 810-c, and 810-d may include resources that span the respective symbol as well as a respective frequency interval 805. In some examples, each symbol 810-a, 810-b, 810-c, and 810-d may include one resource over which an SRS is configured to be transmitted and the remaining resources may be unused resources 815. For instance, symbol 810-a may include first sub-hop resource 820, symbol 810-b may include second sub-hop resource 825, symbol 810-c may include third sub-hop resource 830, and symbol 810-d may include fourth sub-hop resources 835. First sub-hop resource 820, second sub-hop resource 825, third sub-hop resource 830, and fourth sub-hop resource 835 may be defined according to a sub-hop sequence.

In some examples, as demonstrated in FIGS. 8B through 8D, a gap 840 may be present that includes symbol 810-b. The gap 840 may, for instance, represent a duration during which a UE 115 has switched to a new BWP; an off duration of a DRX cycle; or a measurement gap. After gap 840 occurs, the UE 115 may determine how sub-hop counting is to resume.

For FIG. 8B, the UE 115 may determine to continue counting as though an SRS was transmitted in symbol 810-b (e.g., even if the SRS was not transmitted). Accordingly, the SRS resources for symbols 810-c and 810-d for sub-hop counting scheme 800-b may match that of sub-hop counting scheme 805, in which no gap 840 is present.

For FIG. 8C, the UE 115 may determine to reset the sub-hop sequence after the gap 840. Accordingly, if sub-hop resource 820 corresponds a first sub-hop of the sequence and sub-hop resource 825 corresponds to a second sub-hop of the sequence, symbol 810-c may include first sub-hop resource 820 and symbol 810-d may include second sub-hop resource 825.

For FIG. 8D, the UE 115 may determine to resume using a last count number before gap 840 occurred. In the present example, as the next sub-hop resource that UE 115 was to use prior to the gap 840 was second sub-hop resource 825, the UE 115 may use second sub-hop resource 825 to transmit an SRS in symbol 810-c and may use third sub-hop resource 830 to transmit an SRS in symbol 810-d.

FIGS. 9A and 9B illustrate examples of reconfiguration schemes 900-a and 900-b that support sounding reference signal configuration and activation for partial frequency sounding in accordance with aspects of the present disclosure. In some examples, reconfiguration schemes 900-a and 900-b may represent a schemes by which a UE 115 may receive a MAC-CE that reconfigures one or more aspects of a PFS pattern.

As illustrated by FIG. 9A, a UE 115 may receive a DCI 905-a scheduling an SRS 920-a. The UE 115 may receive a MAC-CE 910-a after the SRS 920-a that includes an indication to reconfigure a PFS pattern and may transmit a MAC-CE hybrid automatic repeat request acknowledgement (HARQ-ACK) 815-a to acknowledge that the MAC-CE 910-a was successfully received. In some examples, if MAC-CE 910-a is received after DCI 905-a is received, the UE 115 may wait to reconfigure the PFS pattern until after SRS 920-a. Accordingly, the UE 115 may use the PFS pattern for SRS 920-a that was used prior to receiving MAC-CE 910-a.

As illustrated by FIG. 9B, a UE 115 may receive a MAC-CE 910-b that includes an indication to reconfigure a PFS pattern and may transmit a MAC-CE HARQ-ACK 915-b to acknowledge that the MAC-CE 910-b was successfully received. After transmitting the MAC-CE HARQ-ACK 915-b, the UE may receive DCI 905-b scheduling an SRS 920-b. In some examples, if DCI 905-b is received after MAC-CE 910-b and/or MAC-CE HARQ-ACK 915-b, the UE 115 may apply the reconfigured PFS pattern to SRS 920-b. That is, the next DCI 905 after the MAC-CE 910-b is considered valid (e.g., a certain period of time after receiving or acknowledging the MAC-CE) may trigger a UE 115 to use the reconfigured PFS pattern.

FIGS. 10A, 10B, and 10C illustrate examples of reconfiguration schemes 1000-a, 1000-b, and 1000-c that support sounding reference signal configuration and activation for partial frequency sounding in accordance with aspects of the present disclosure. In some examples, reconfiguration schemes 1000-a, 1000-b, and 1000-c may represent schemes by which a UE 115 may receive a MAC-CE that reconfigures one or more aspects of a PFS pattern.

The present disclosure may describe a set of rules to determine if a

reconfiguration of a PFS pattern is to be applied following reception of a MAC-CE. For instance, if an SRS is scheduled for transmission within a time duration t₁ (e.g., a time duration for the MAC-CE to be valid, 3 milliseconds) following transmission of a MAC-CE HARQ ACK, a UE 115 may not apply the reconfigured PFS pattern to the SRS. However, if the SRS is scheduled for transmission outside of time duration t₁, the UE 115 may apply the reconfigured PFS pattern to the SRS. Additionally, if an SRS is scheduled for transmission after the time duration t₁ but within a time duration t₂ (e.g., a time duration for applying setting changes associated with the reconfiguration) following t₁, the UE 115 may use a pre-defined pattern for the SRS or may use the pattern that the UE 115 was configured to apply to SRSs prior to receiving the MAC-CE. However, if the SRS is scheduled for transmission after time durations t₁and t₂, the UE 115 may apply the reconfigured PFS pattern to the SRS. Examples of these rules being applied may be illustrated with reference to FIGS. 10A, 10B, and 10C.

As illustrated in FIG. 10A, a UE 115 may receive a MAC-CE that indicates a reconfigured PFS pattern and may transmit MAC-CE HARQ ACK 1015-a. In examples in which SRS 1020-a is received after a time duration 1005 (e.g., 3 milliseconds), which may represent a duration for the MAC-CE to be valid, the UE 115 may apply the reconfigured PFS pattern to SRS 1020-a.

As illustrated in FIG. 10B, a UE 115 may receive a MAC-CE that indicates a reconfigured PFS pattern and may transmit MAC-CE HARQ ACK 1015-b. In some examples in which SRS 1020-b is received after a time duration 1005 (e.g., 3 milliseconds) and time duration 1010, which may represent a time for the UE 115 to apply setting changes associated with the MAC-CE, the UE 115 may apply the reconfigured PFS pattern to SRS 1020-b.

As illustrated in FIG. 10C, a UE 115 may receive a MAC-CE that indicates a reconfigured PFS pattern and may transmit MAC-CE HARQ ACK 1015-c. In some examples in which SRS 1020-c is received after a time duration 1005 (e.g., 3 milliseconds) but during time duration 1010, which may represent a time for the UE 115 to apply setting changes associated with the MAC-CE, the UE 115 may use a pre-defined pattern for the SRS 1020-c or may ignore the MAC-CE for the SRS 1020-c (e.g., use the pattern that the UE 115 was configured apply to SRSs prior to receiving the MAC-CE).

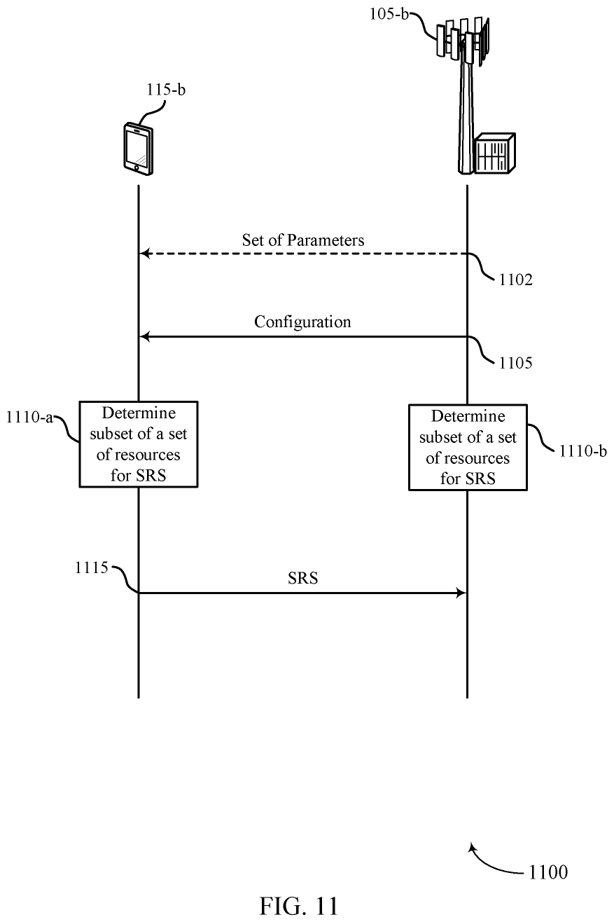

FIG. 11 illustrates an example of a process flow 1100 that supports sounding reference signal configuration and activation for partial frequency sounding in accordance with aspects of the present disclosure. In some examples process flow 1100 may be implemented by one or more aspects of wireless communications system 100.

For instance, UE 115-b may be an example of a UE 115 as described with reference to FIG. 1 and base station 105-b may be an example of a base station 105 as described with reference to FIG. 1.

At 1102, base station 105-b may transmit, to UE 115-b, an indication of the set of parameters that includes a first parameter. The first parameter may, for instance, be n_{PFS}^{shift}, bₕₒₚ^{PFS}, B_{PFS}, or R′ as described herein, for instance, with reference to FIG. 2.

At 1105, base station 105-b may transmit, to UE 115-b, control signaling identifying a configuration for a full-frequency sounding SRS (e.g., an SRS configured to be transmitted over an entire bandwidth). In some examples, the control signaling may be provided via RRC signaling or MAC-CE signaling.

At 1110-a, UE 115-b may determine, based on the configuration and a set of parameters associated with PFS of the full-frequency sounding SRS, a subset of a set of resources configured for the full-frequency sounding SRS. For instance, the set of resources may be divided over multiple symbols into contiguous groups of resources. A first group of contiguous resources of the set of resources may reside within a first symbol and may span a first portion of the bandwidth and a second group of contiguous resources of the set of resources may reside within a second symbol and may span a second portion of the bandwidth. In some examples, each group of contiguous resources may have a respective one of the resources in the subset of the set of resources. Accordingly, the subset of the set of resources may exclude at least one resource of the set of resources (e.g., the other resources in each group that are not the one selected for transmitting the SRS). At 1110-b, base station 105-b may determine, based on the configuration and the set of parameters (e.g., associated with PFS of the full-frequency sounding SRS), the subset of the set of resources. In some examples, determining the subset of the set of resources includes determining a position of a resource of a first symbol of a starting position and a sub-hop pattern.

At 1115, UE 115-b may transmit, to base station 105-b, a PFS SRS (e.g., an SRS configured to be transmitted over a portion of a bandwidth) over the subset of the set of resources. In some examples, transmitting the PFS SRS includes transmitting the PFS SRS according to the starting position and the sub-hop pattern.

In some such examples, determining the starting position may be based on the first parameter (e.g., indicated at 1102), and transmitting the PFS SRS may include transmitting the PFS SRS over the resource of the first symbol based on the first parameter. In some such examples, determining the sub-hop pattern based on the first parameter.

In some examples, UE 115-b may apply the sub-hop pattern to the PFS SRS based on the first parameter failing to satisfy a threshold. For instance, if bₕₒₚ^{PFS}<B_{PFS}, UE 115-b may apply the sub-hop pattern. In some examples, UE 115-b may receive MAC-CE signaling that reconfigures the starting position, the sub-hop pattern, or both. In some examples, UE 115-b may transmit a third sounding reference signal according to the reconfigured starting position, the reconfigured sub-hop pattern, or both.

In some examples, UE 115-b may receive the MAC-CE signaling before transmitting the PFS SRS, where transmitting the PFS SRS according to the starting position and the sub-hop pattern is based on receiving the MAC control element signaling within a threshold time relative to transmitting the PFS SRS, and where transmitting the third sounding reference signal according to the reconfigured starting position, the reconfigured sub-hop pattern, or both is based on receiving the MAC control element signaling prior to the threshold time relative to transmitting the third sounding reference signal.

In some examples, UE 115-a may determine the sub-hop pattern according to a sub-hop index. In some examples, the set of resources are associated with a set of symbols. In some examples, each symbol of the set of symbols is associated with two or more resources of the set of resources that are contiguous with each other. In some examples, the two or more resources for each symbol have an order. In some examples, determining the subset of the set of resources includes determining an index for the each symbol. In some examples, a position in the order for the subset of the set of resources for the each symbol is based on the corresponding index. In some examples, as illustrated with reference to FIG. 7A, each index is based on a position of the corresponding symbol relative to each other symbol of the set of symbols. In some examples, as illustrated with reference to FIG. 7B, each index is based on a hop number associated with the symbol corresponding to each index.

In some examples, UE 115-b may begin transmitting full-frequency SRS

again after an intervening gap occurs. For instance, in some examples, the set of resources are configured for each of a first slot and a second slot that occurs after the first slot, where the PFS SRS is transmitted during the first slot. In some such examples, UE 115-b may transmit, during the second slot, the full-frequency sounding SRS over each resource of the set of resources configured for the second slot. In some examples,

UE 115-b may determine, after transmitting the PFS SRS, that a measurement gap is larger than a threshold, that bandwidth part switching has occurred, or both, where transmitting the full-frequency sounding SRS over each resource of the set of resources configured for the second slot is based on determining that the measurement gap is larger than the threshold, that bandwidth part switching has occurred, or both.

In some examples, as illustrated in FIG. 8B, UE 115-b may identify a sequence of indices associated with a sequence of symbols including respective resources of the subset of the set of resources. In some examples, UE 115-b may refrain from transmitting the PFS SRS during a first symbol the sequence of symbols based on identifying a gap including the first symbol, where transmitting the PFS SRS includes transmitting the PFS SRS in a second symbol of the sequence of symbols subsequent to the gap according to a corresponding index of the sequence of indices.

In some examples, as illustrated in FIG. 8C, UE 115-b may identify a sequence of indices associated with a sequence of symbols including respective resources of the subset of the set of resources. In some examples, UE 115-b may refrain from transmitting the PFS SRS during a first symbol the sequence of symbols based on identifying a gap including the first symbol. In some examples, UE 115-b may reset the sequence of indices at a second symbol subsequent to the gap such that the second symbol is associated with an initial index of the sequence of indices based on the first symbol being within the gap, where transmitting the PFS SRS includes transmitting the PFS SRS in the second symbol based on the initial index (e.g., as illustrated in FIG. 8C).

In some examples, as illustrated in FIG. 8D, UE 115-b may identify a sequence of indices associated with a sequence of symbols including respective resources of the subset of the set of resources. In some examples, UE 115-b may refrain from transmitting the PFS SRS during a first symbol the sequence of symbols based on identifying a gap including the first symbol. In some examples, UE 115-b may defer an index of the sequence of indices corresponding to the first symbol to a second symbol subsequent to the gap, where transmitting the PFS SRS includes transmitting the PFS SRS in the second symbol based on the deferred index.

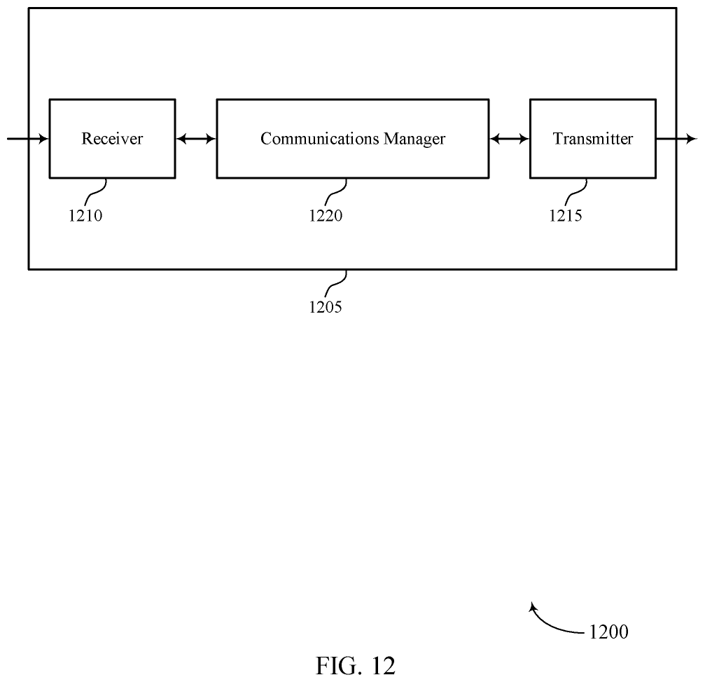

FIG. 12 shows a block diagram 1200 of a device 1205 that supports sounding reference signal configuration and activation for partial frequency sounding in accordance with aspects of the present disclosure. The device 1205 may be an example of aspects of a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to sounding reference signal configuration and activation for partial frequency sounding). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to sounding reference signal configuration and activation for partial frequency sounding). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of sounding reference signal configuration and activation for partial frequency sounding as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1220 may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a UE in accordance with examples as disclosed herein. For example, the communications manager 1220 may be configured as or otherwise support a means for receiving, from a base station, control signaling identifying a configuration for a first sounding reference signal. The communications manager 1220 may be configured as or otherwise support a means for determining, based on the configuration and a set of parameters associated with partial frequency sounding of the first sounding reference signal, a subset of a set of resources configured for the first sounding reference signal, where the subset of the set of resources excludes at least one resource of the set of resources. The communications manager 1220 may be configured as or otherwise support a means for transmitting, to the base station, a second sounding reference signal over the subset of the set of resources.

By including or configuring the communications manager 1220 in accordance with examples as described herein, the device 1205 (e.g., a processor controlling or otherwise coupled to the receiver 1210, the transmitter 1215, the communications manager 1220, or a combination thereof) may support techniques for the device 1205 to use fewer resources when transmitting a sounding reference signal.

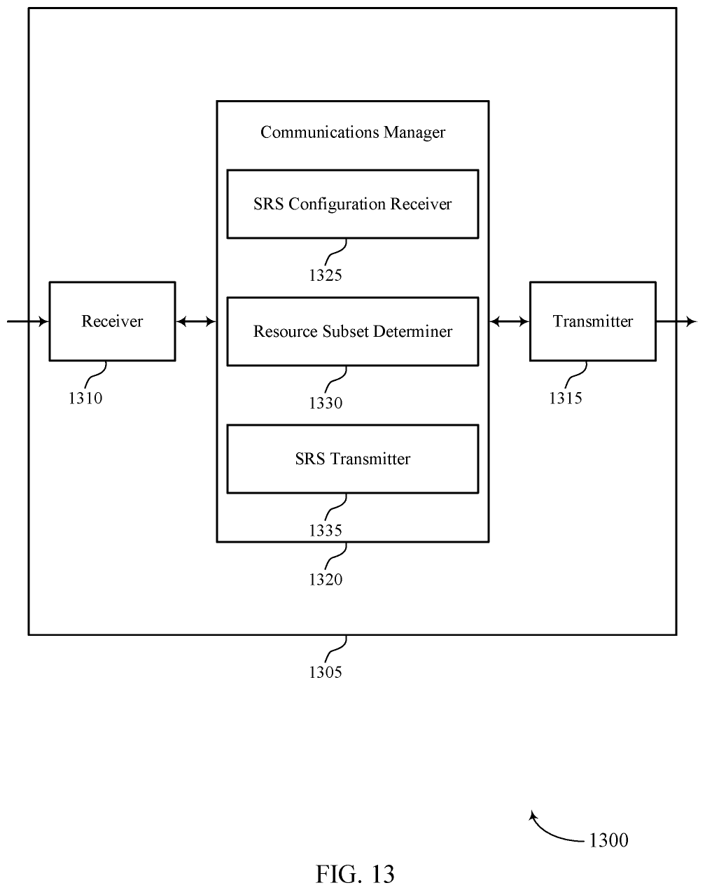

FIG. 13 shows a block diagram 1300 of a device 1305 that supports sounding reference signal configuration and activation for partial frequency sounding in accordance with aspects of the present disclosure. The device 1305 may be an example of aspects of a device 1205 or a UE 115 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to sounding reference signal configuration and activation for partial frequency sounding). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to sounding reference signal configuration and activation for partial frequency sounding). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of sounding reference signal configuration and activation for partial frequency sounding as described herein. For example, the communications manager 1320 may include an SRS configuration receiver 1325, a resource subset determiner 1330, an SRS transmitter 1335, or any combination thereof. The communications manager 1320 may be an example of aspects of a communications manager 1220 as described herein. In some examples, the communications manager 1320, or various components thereof, may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communication at a UE in accordance with examples as disclosed herein. The SRS configuration receiver 1325 may be configured as or otherwise support a means for receiving, from a base station, control signaling identifying a configuration for a first sounding reference signal. The resource subset determiner 1330 may be configured as or otherwise support a means for determining, based on the configuration and a set of parameters associated with partial frequency sounding of the first sounding reference signal, a subset of a set of resources configured for the first sounding reference signal, where the subset of the set of resources excludes at least one resource of the set of resources. The SRS transmitter 1335 may be configured as or otherwise support a means for transmitting, to the base station, a second sounding reference signal over the subset of the set of resources.

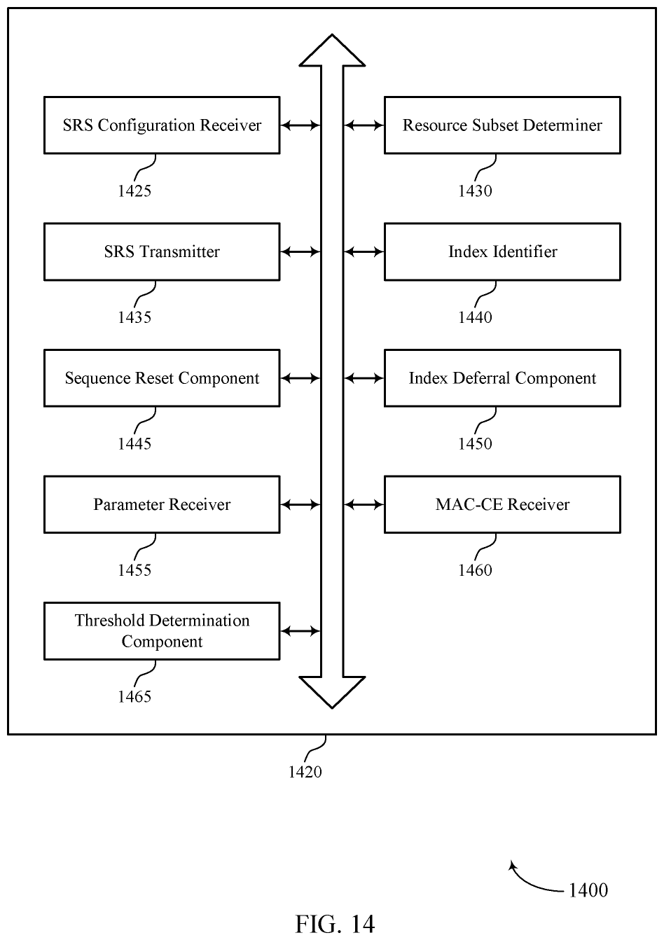

FIG. 14 shows a block diagram 1400 of a communications manager 1420 that supports sounding reference signal configuration and activation for partial frequency sounding in accordance with aspects of the present disclosure. The communications manager 1420 may be an example of aspects of a communications manager 1220, a communications manager 1320, or both, as described herein. The communications manager 1420, or various components thereof, may be an example of means for performing various aspects of sounding reference signal configuration and activation for partial frequency sounding as described herein. For example, the communications manager 1420 may include an SRS configuration receiver 1425, a resource subset determiner 1430, an SRS transmitter 1435, an index identifier 1440, a sequence reset component 1445, an index deferral component 1450, a parameter receiver 1455, a MAC-CE receiver 1460, a threshold determination component 1465, or any combination thereof. Each of these components may communicate, directly or indirectly, with one another (e.g., via one or more buses).

The communications manager 1420 may support wireless communication at a UE in accordance with examples as disclosed herein. The SRS configuration receiver 1425 may be configured as or otherwise support a means for receiving, from a base station, control signaling identifying a configuration for a first sounding reference signal. The resource subset determiner 1430 may be configured as or otherwise support a means for determining, based on the configuration and a set of parameters associated with partial frequency sounding of the first sounding reference signal, a subset of a set of resources configured for the first sounding reference signal, where the subset of the set of resources excludes at least one resource of the set of resources. The SRS transmitter 1435 may be configured as or otherwise support a means for transmitting, to the base station, a second sounding reference signal over the subset of the set of resources.

In some examples, determining the subset of the set of resources includes determining a position of a resource of a first symbol of a set of symbols and a resource pattern relative to the resource for each other symbol of the set of symbols, where the first symbol occurs before each other symbol of the set of symbols. In some examples, transmitting the second sounding reference signal includes transmitting the second sounding reference signal over the resource of the first symbol and one or more resources of each other symbol of the set of symbols based on determining the position of the resource of the first symbol and the resource pattern.

In some examples, the parameter receiver 1455 may be configured as or otherwise support a means for receiving an indication of the set of parameters that includes a first parameter, where determining the position of the resource of the first symbol of the set of symbols is based on the first parameter, where transmitting the second sounding reference signal includes transmitting the second sounding reference signal over the resource of the first symbol based on the first parameter.

In some examples, the parameter receiver 1455 may be configured as or otherwise support a means for receiving an indication of the set of parameters that includes a first parameter, where determining the resource pattern relative to the resource for each other symbol of the set of symbols is based on the first parameter.

In some examples, the resource pattern includes a frequency hopping pattern based on the first parameter failing to satisfy a threshold.

In some examples, the MAC-CE receiver 1460 may be configured as or otherwise support a means for receiving medium access control (MAC) control element signaling that reconfigures the position of the resource, the resource pattern, or both. In some examples, the SRS transmitter 1435 may be configured as or otherwise support a means for transmitting a third sounding reference signal according to the reconfigured position of the resource, the reconfigured resource pattern, or both.

In some examples, the MAC-CE receiver 1460 may be configured as or otherwise support a means for receiving the MAC control element signaling before transmitting the second sounding reference signal, where transmitting the second sounding reference signal according to the position of the resource of the first symbol and the resource pattern is based on receiving the MAC control element signaling within a threshold time relative to transmitting the second sounding reference signal, and where transmitting the third sounding reference signal according to the reconfigured position of the resource, the reconfigured resource pattern, or both is based on receiving the MAC control element signaling prior to the threshold time relative to transmitting the third sounding reference signal.

In some examples, the set of resources are associated with a set of symbols. In some examples, each symbol of the set of symbols is associated with two or more resources of the set of resources that are contiguous with each other. In some examples, the two or more resources for each symbol have an order. In some examples, determining the subset of the set of resources includes determining an index for the each symbol. In some examples, a position in the order for the subset of the set of resources for the each symbol is based on the corresponding index.

In some examples, each index is based on a position of the corresponding symbol relative to each other symbol of the set of symbols.

In some examples, each index is based on a hop number associated with the symbol corresponding to each index.

In some examples, the set of resources are configured for each of a first slot and a second slot that occurs after the first slot, where the second sounding reference signal is transmitted during the first slot, and the SRS transmitter 1435 may be configured as or otherwise support a means for transmitting, during the second slot, the first sounding reference signal over each resource of the set of resources configured for the second slot.

In some examples, the threshold determination component 1465 may be configured as or otherwise support a means for determining, after transmitting the second sounding reference signal, that a measurement gap is larger than a threshold, that bandwidth part switching has occurred, or both, where transmitting the first sounding reference signal over each resource of the set of resources configured for the second slot is based on determining that the measurement gap is larger than the threshold, that bandwidth part switching has occurred, or both.

In some examples, the index identifier 1440 may be configured as or otherwise support a means for identifying a sequence of indices associated with a sequence of symbols including respective resources of the subset of the set of resources. In some examples, the SRS transmitter 1435 may be configured as or otherwise support a means for refraining from transmitting the second sounding reference signal during a first symbol the sequence of symbols based on identifying a gap including the first symbol, where transmitting the second sounding reference signal includes transmitting the second sounding reference signal in a second symbol of the sequence of symbols subsequent to the gap according to a corresponding index of the sequence of indices.

In some examples, the index identifier 1440 may be configured as or otherwise support a means for identifying a sequence of indices associated with a sequence of symbols including respective resources of the subset of the set of resources. In some examples, the SRS transmitter 1435 may be configured as or otherwise support a means for refraining from transmitting the second sounding reference signal during a first symbol the sequence of symbols based on identifying a gap including the first symbol. In some examples, the sequence reset component 1445 may be configured as or otherwise support a means for resetting the sequence of indices at a second symbol subsequent to the gap such that the second symbol is associated with an initial index of the sequence of indices based on the first symbol being within the gap, where transmitting the second sounding reference signal includes transmitting the second sounding reference signal in the second symbol based on the initial index.

In some examples, the index identifier 1440 may be configured as or otherwise support a means for identifying a sequence of indices associated with a sequence of symbols including respective resources of the subset of the set of resources.

In some examples, the SRS transmitter 1435 may be configured as or otherwise support a means for refraining from transmitting the second sounding reference signal during a first symbol the sequence of symbols based on identifying a gap including the first symbol. In some examples, the index deferral component 1450 may be configured as or otherwise support a means for deferring an index of the sequence of indices corresponding to the first symbol to a second symbol subsequent to the gap, where transmitting the second sounding reference signal includes transmitting the second sounding reference signal in the second symbol based on the deferred index.

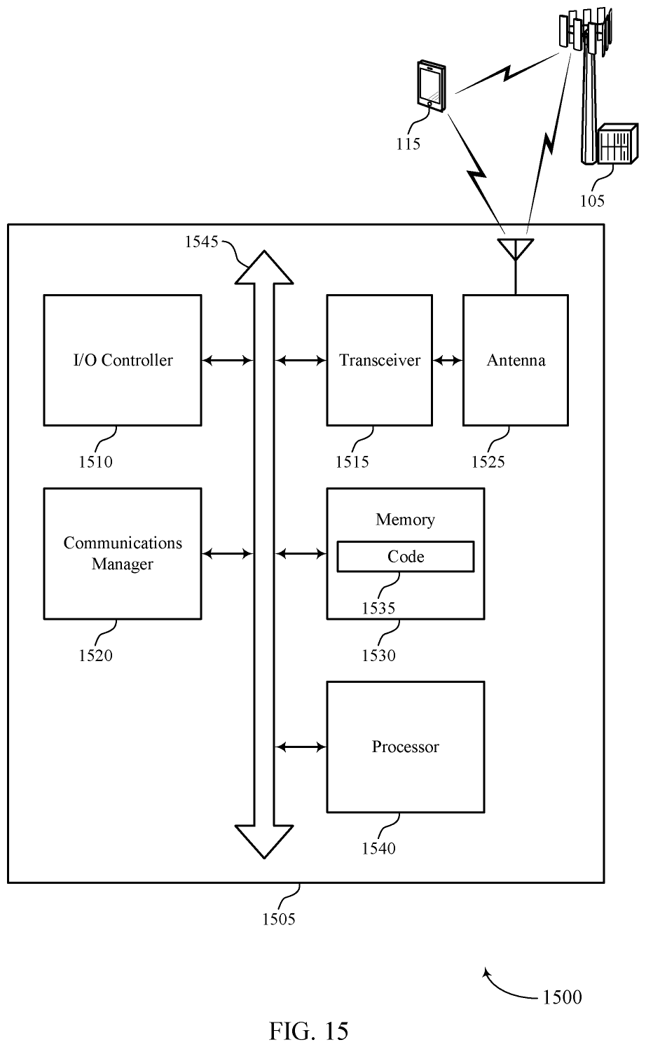

FIG. 15 shows a diagram of a system 1500 including a device 1505 that supports sounding reference signal configuration and activation for partial frequency sounding in accordance with aspects of the present disclosure. The device 1505 may be an example of or include the components of a device 1205, a device 1305, or a UE 115 as described herein. The device 1505 may communicate wirelessly with one or more base stations 105, UEs 115, or any combination thereof. The device 1505 may include components for bi-directional voice and data communications including components for transmitting and receiving communications, such as a communications manager 1520, an input/output (I/O) controller 1510, a transceiver 1515, an antenna 1525, a memory 1530, code 1535, and a processor 1540. These components may be in electronic communication or otherwise coupled (e.g., operatively, communicatively, functionally, electronically, electrically) via one or more buses (e.g., a bus 1545).

The I/O controller 1510 may manage input and output signals for the device 1505. The I/O controller 1510 may also manage peripherals not integrated into the device 1505. In some cases, the I/O controller 1510 may represent a physical connection or port to an external peripheral. In some cases, the I/O controller 1510 may utilize an operating system such as iOS®, ANDROID®, MS-DOS®, MS-WINDOWS®, OS/2®, UNIX®, LINUX®, or another known operating system. Additionally or alternatively, the I/O controller 1510 may represent or interact with a modem, a keyboard, a mouse, a touchscreen, or a similar device. In some cases, the I/O controller 1510 may be implemented as part of a processor, such as the processor 1540. In some cases, a user may interact with the device 1505 via the I/O controller 1510 or via hardware components controlled by the I/O controller 1510.

In some cases, the device 1505 may include a single antenna 1525. However, in some other cases, the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The memory 1530 may include random access memory (RAM) and read-only memory (ROM). The memory 1530 may store computer-readable, computer-executable code 1535 including instructions that, when executed by the processor 1540, cause the device 1505 to perform various functions described herein. The code 1535 may be stored in a non-transitory computer-readable medium such as system memory or another type of memory. In some cases, the code 1535 may not be directly executable by the processor 1540 but may cause a computer (e.g., when compiled and executed) to perform functions described herein. In some cases, the memory 1530 may contain, among other things, a basic I/O system (BIOS) which may control basic hardware or software operation such as the interaction with peripheral components or devices.

The processor 1540 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some other cases, a memory controller may be integrated into the processor 1540. The processor 1540 may be configured to execute computer-readable instructions stored in a memory (e.g., the memory 1530) to cause the device 1505 to perform various functions (e.g., functions or tasks supporting sounding reference signal configuration and activation for partial frequency sounding). For example, the device 1505 or a component of the device 1505 may include a processor 1540 and memory 1530 coupled to the processor 1540, the processor 1540 and memory 1530 configured to perform various functions described herein.

The communications manager 1520 may support wireless communication at a UE in accordance with examples as disclosed herein. For example, the communications manager 1520 may be configured as or otherwise support a means for receiving, from a base station, control signaling identifying a configuration for a first sounding reference signal. The communications manager 1520 may be configured as or otherwise support a means for determining, based on the configuration and a set of parameters associated with partial frequency sounding of the first sounding reference signal, a subset of a set of resources configured for the first sounding reference signal, where the subset of the set of resources excludes at least one resource of the set of resources. The communications manager 1520 may be configured as or otherwise support a means for transmitting, to the base station, a second sounding reference signal over the subset of the set of resources.

By including or configuring the communications manager 1520 in accordance with examples as described herein, the device 1505 may support techniques for support techniques for the device 1505 to use fewer resources when transmitting a sounding reference signal.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the processor 1540, the memory 1530, the code 1535, or any combination thereof. For example, the code 1535 may include instructions executable by the processor 1540 to cause the device 1505 to perform various aspects of sounding reference signal configuration and activation for partial frequency sounding as described herein, or the processor 1540 and the memory 1530 may be otherwise configured to perform or support such operations.

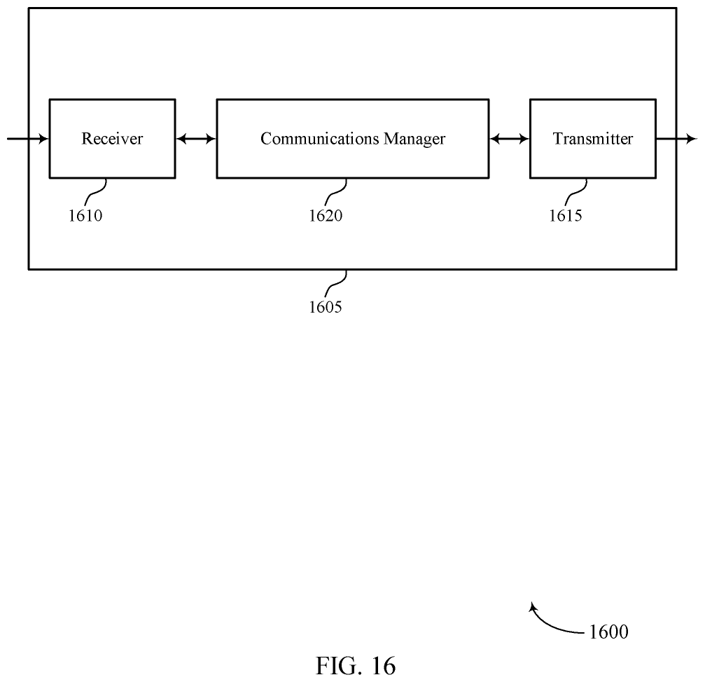

FIG. 16 shows a block diagram 1600 of a device 1605 that supports sounding reference signal configuration and activation for partial frequency sounding in accordance with aspects of the present disclosure. The device 1605 may be an example of aspects of a base station 105 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for receiving information such as packets, user data, control information, or any combination thereof associated with various information channels (e.g., control channels, data channels, information channels related to sounding reference signal configuration and activation for partial frequency sounding). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to sounding reference signal configuration and activation for partial frequency sounding). In some examples, the transmitter 1615 may be co-located with a receiver 1610 in a transceiver module. The transmitter 1615 may utilize a single antenna or a set of multiple antennas.

The communications manager 1620, the receiver 1610, the transmitter 1615, or various combinations thereof or various components thereof may be examples of means for performing various aspects of sounding reference signal configuration and activation for partial frequency sounding as described herein. For example, the communications manager 1620, the receiver 1610, the transmitter 1615, or various combinations or components thereof may support a method for performing one or more of the functions described herein.

In some examples, the communications manager 1620, the receiver 1610, the transmitter 1615, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory). Additionally or alternatively, in some examples, the communications

manager 1620, the receiver 1610, the transmitter 1615, or various combinations or components thereof may be implemented in code (e.g., as communications management software or firmware) executed by a processor. If implemented in code executed by a processor, the functions of the communications manager 1620, the receiver 1610, the transmitter 1615, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1620 may be configured to perform various operations (e.g., receiving, monitoring, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to receive information, transmit information, or perform various other operations as described herein.

The communications manager 1620 may support wireless communication at

a base station in accordance with examples as disclosed herein. For example, the communications manager 1620 may be configured as or otherwise support a means for transmitting, to a UE, control signaling identifying a configuration for a first sounding reference signal. The communications manager 1620 may be configured as or otherwise support a means for determining, based on the configuration and a set of parameters associated with partial frequency sounding of the first sounding reference signal, a subset of a set of resources configured for the first sounding reference signal, where the subset of the set of resources excludes at least one resource of the set of resources. The communications manager 1620 may be configured as or otherwise support a means for receiving, from the UE, a second sounding reference signal over the subset of the set of resources.

By including or configuring the communications manager 1620 in accordance with examples as described herein, the device 1605 (e.g., a processor controlling or otherwise coupled to the receiver 1610, the transmitter 1615, the communications manager 1620, or a combination thereof) may support techniques for the device 1605 to use fewer resources when receiving a sounding reference signal.

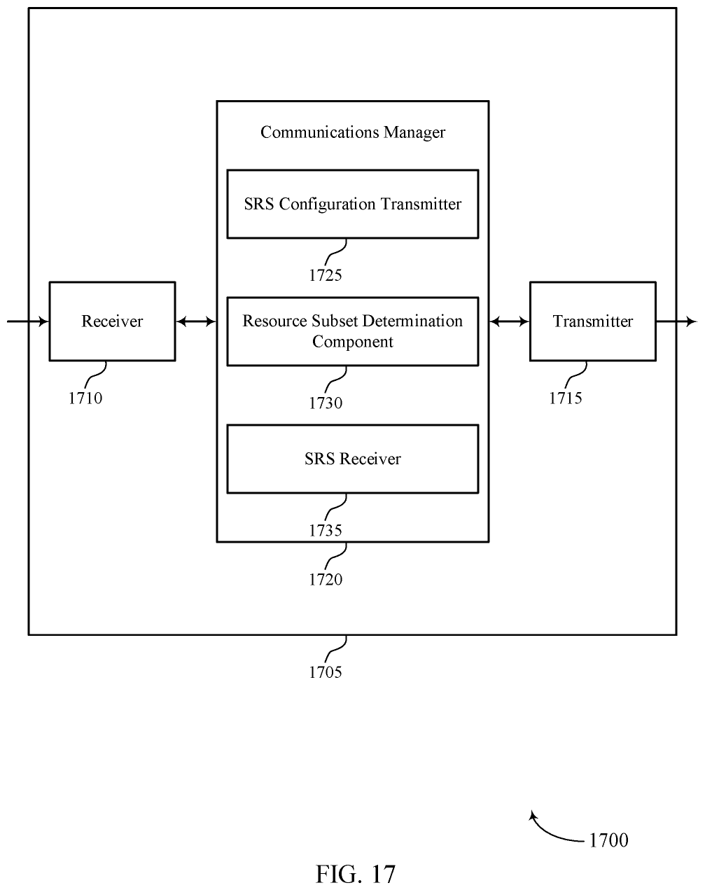

FIG. 17 shows a block diagram 1700 of a device 1705 that supports sounding reference signal configuration and activation for partial frequency sounding in accordance with aspects of the present disclosure. The device 1705 may be an example of aspects of a device 1605 or a base station 105 as described herein. The device 1705 may include a receiver 1710, a transmitter 1715, and a communications manager 1720. The device 1705 may also include a processor. Each of these components may be in communication with one another (e.g., via one or more buses).

The receiver 1710 may provide a means for receiving information such as packets, user data, control information, or any combination thereof associated with various information channels (e.g., control channels, data channels, information channels related to sounding reference signal configuration and activation for partial frequency sounding). Information may be passed on to other components of the device 1705. The receiver 1710 may utilize a single antenna or a set of multiple antennas.

The transmitter 1715 may provide a means for transmitting signals generated by other components of the device 1705. For example, the transmitter 1715 may transmit information such as packets, user data, control information, or any combination thereof associated with various information channels (e.g., control channels, data channels, information channels related to sounding reference signal configuration and activation for partial frequency sounding). In some examples, the transmitter 1715 may be co-located with a receiver 1710 in a transceiver module. The transmitter 1715 may utilize a single antenna or a set of multiple antennas.

The device 1705, or various components thereof, may be an example of means for performing various aspects of sounding reference signal configuration and activation for partial frequency sounding as described herein. For example, the communications manager 1720 may include an SRS configuration transmitter 1725, a resource subset determination component 1730, an SRS receiver 1735, or any combination thereof. The communications manager 1720 may be an example of aspects of a communications manager 1620 as described herein. In some examples, the communications manager 1720, or various components thereof, may be configured to perform various operations (e.g., receiving, monitoring, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to receive information, transmit information, or perform various other operations as described herein.

The communications manager 1720 may support wireless communication at a base station in accordance with examples as disclosed herein. The SRS configuration transmitter 1725 may be configured as or otherwise support a means for transmitting, to a UE, control signaling identifying a configuration for a first sounding reference signal. The resource subset determination component 1730 may be configured as or otherwise support a means for determining, based on the configuration and a set of parameters associated with partial frequency sounding of the first sounding reference signal, a subset of a set of resources configured for the first sounding reference signal, where the subset of the set of resources excludes at least one resource of the set of resources. The SRS receiver 1735 may be configured as or otherwise support a means for receiving, from the UE, a second sounding reference signal over the subset of the set of resources.

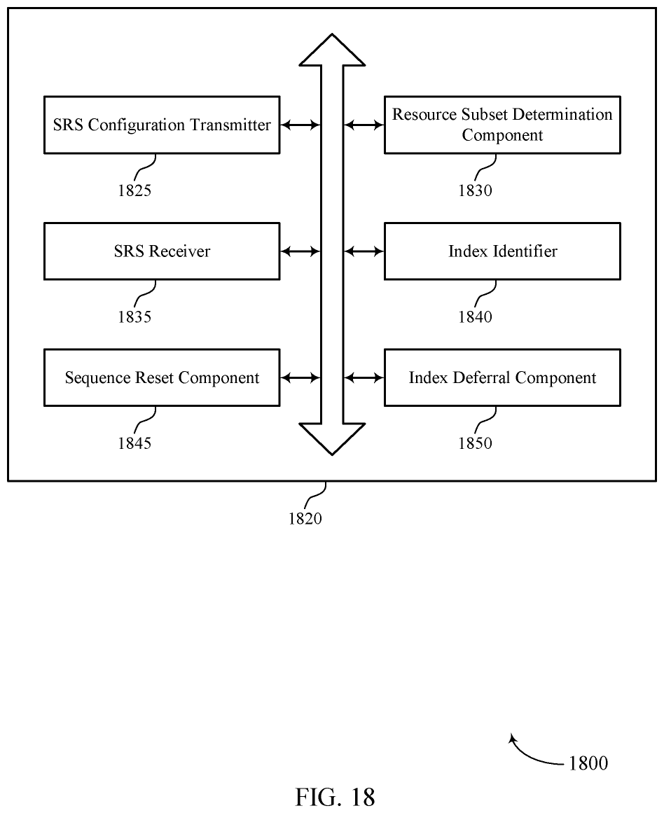

FIG. 18 shows a block diagram 1800 of a communications manager 1820 that supports sounding reference signal configuration and activation for partial frequency sounding in accordance with aspects of the present disclosure. The communications manager 1820 may be an example of aspects of a communications manager 1620, a communications manager 1720, or both, as described herein. The communications manager 1820, or various components thereof, may be an example of means for performing various aspects of sounding reference signal configuration and activation for partial frequency sounding as described herein. For example, the communications manager 1820 may include an SRS configuration transmitter 1825, a resource subset determination component 1830, an SRS receiver 1835, an index identifier 1840, a sequence reset component 1845, an index deferral component 1850, or any combination thereof. Each of these components may communicate, directly or indirectly, with one another (e.g., via one or more buses).

The communications manager 1820 may support wireless communication at a base station in accordance with examples as disclosed herein. The SRS configuration transmitter 1825 may be configured as or otherwise support a means for transmitting, to a UE, control signaling identifying a configuration for a first sounding reference signal. The resource subset determination component 1830 may be configured as or otherwise support a means for determining, based on the configuration and a set of parameters associated with partial frequency sounding of the first sounding reference signal, a subset of a set of resources configured for the first sounding reference signal, where the subset of the set of resources excludes at least one resource of the set of resources. The SRS receiver 1835 may be configured as or otherwise support a means for receiving, from the UE, a second sounding reference signal over the subset of the set of resources.

In some examples, determining the subset of the set of resources includes determining a position of a resource of a first symbol of a set of symbols and a resource pattern relative to the resource for each other symbol of the set of symbols, where the first symbol occurs before each other symbol of the set of symbols. In some examples, receiving the second sounding reference signal includes receiving the second sounding reference signal over the resource of the first symbol and one or more resources of each other symbol of the set of symbols based on determining the position of the resource of the first symbol and the resource pattern.

In some examples, the set of resources are associated with a set of symbols. In some examples, each symbol of the set of symbols is associated with two or more resources of the set of resources that are contiguous with each other. In some examples, the two or more resources for each symbol have an order. In some examples, determining the subset of the set of resources includes determining an index for the each symbol. In some examples, a position in the order for the subset of the set of resources for the each symbol is based on the corresponding index.

In some examples, the set of resources are configured for each of a first slot and a second slot that occurs after the first slot, where the second sounding reference signal is received during the slot, and the SRS receiver 1835 may be configured as or otherwise support a means for receiving, during the second slot, the first sounding reference signal over each resource of the set of resources configured for the second slot.

In some examples, the index identifier 1840 may be configured as or otherwise support a means for identifying a sequence of indices associated with a sequence of symbols including respective resources of the subset of the set of resources. In some examples, the SRS receiver 1835 may be configured as or otherwise support a means for refraining from receiving the second sounding reference signal during a first symbol the sequence of symbols based on identifying a gap including the first symbol, where receiving the second sounding reference signal includes receiving the second sounding reference signal in a second symbol of the sequence of symbols subsequent to the gap according to a corresponding index of the sequence of indices.

In some examples, the index identifier 1840 may be configured as or otherwise support a means for identifying a sequence of indices associated with a sequence of symbols including respective resources of the subset of the set of resources. In some examples, the SRS receiver 1835 may be configured as or otherwise support a means for refraining from receiving the second sounding reference signal during a first symbol the sequence of symbols based on identifying a gap including the first symbol. In some examples, the sequence reset component 1845 may be configured as or otherwise support a means for resetting the sequence of indices at a second symbol subsequent to the gap such that the second symbol is associated with an initial index of the sequence of indices based on the first symbol being within the gap, where receiving the second sounding reference signal includes receiving the second sounding reference signal in the second symbol based on the initial index.

In some examples, the index identifier 1840 may be configured as or otherwise support a means for identifying a sequence of indices associated with a sequence of symbols including respective resources of the subset of the set of resources. In some examples, the SRS receiver 1835 may be configured as or otherwise support a means for refraining from receiving the second sounding reference signal during a first symbol the sequence of symbols based on identifying a gap including the first symbol. In some examples, the index deferral component 1850 may be configured as or otherwise support a means for deferring an index of the sequence of indices corresponding to the first symbol to a second symbol subsequent to the gap, where receiving the second sounding reference signal includes receiving the second sounding reference signal in the second symbol based on the deferred index.

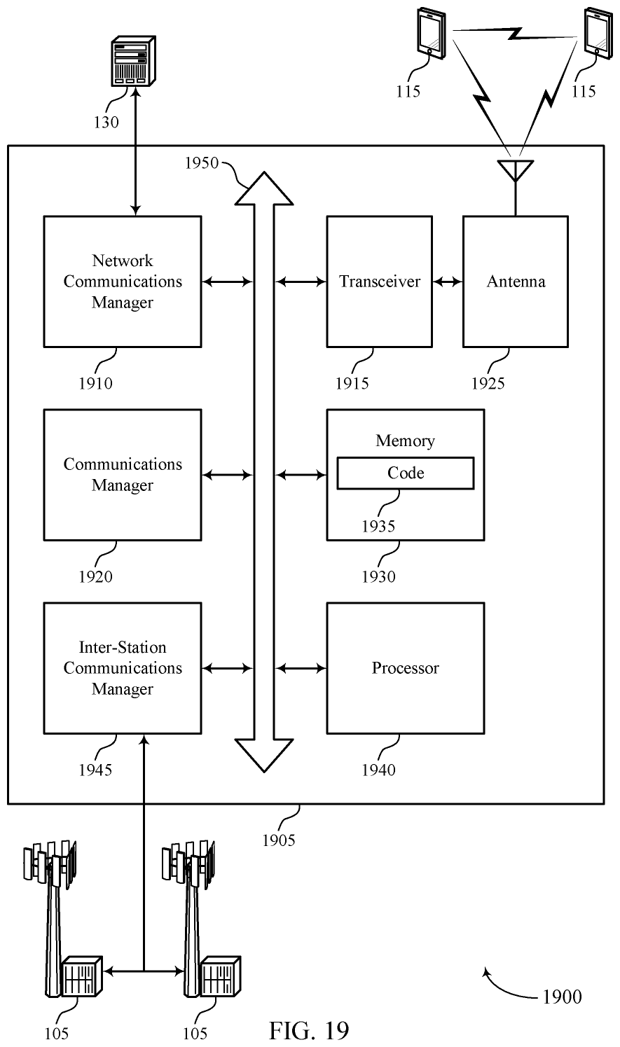

FIG. 19 shows a diagram of a system 1900 including a device 1905 that supports sounding reference signal configuration and activation for partial frequency sounding in accordance with aspects of the present disclosure. The device 1905 may be an example of or include the components of a device 1605, a device 1705, or a base station 105 as described herein. The device 1905 may communicate wirelessly with one or more base stations 105, UEs 115, or any combination thereof. The device 1905 may include components for bi-directional voice and data communications including components for transmitting and receiving communications, such as a communications manager 1920, a network communications manager 1910, a transceiver 1915, an antenna 1925, a memory 1930, code 1935, a processor 1940, and an inter-station communications manager 1945. These components may be in electronic communication or otherwise coupled (e.g., operatively, communicatively, functionally, electronically, electrically) via one or more buses (e.g., a bus 1950).

The network communications manager 1910 may manage communications with a core network 130 (e.g., via one or more wired backhaul links). For example, the network communications manager 1910 may manage the transfer of data communications for client devices, such as one or more UEs 115.

In some cases, the device 1905 may include a single antenna 1925. However, in some other cases the device 1905 may have more than one antenna 1925, which may be capable of concurrently transmitting or receiving multiple wireless transmissions. The transceiver 1915 may communicate bi-directionally, via the one or more antennas 1925, wired, or wireless links as described herein. For example, the transceiver 1915 may represent a wireless transceiver and may communicate bi-directionally with another wireless transceiver. The transceiver 1915 may also include a modem to modulate the packets, to provide the modulated packets to one or more antennas 1925 for transmission, and to demodulate packets received from the one or more antennas 1925. The transceiver 1915, or the transceiver 1915 and one or more antennas 1925, may be an example of a transmitter 1615, a transmitter 1715, a receiver 1610, a receiver 1710, or any combination thereof or component thereof, as described herein.

The memory 1930 may include RAM and ROM. The memory 1930 may store computer-readable, computer-executable code 1935 including instructions that, when executed by the processor 1940, cause the device 1905 to perform various functions described herein. The code 1935 may be stored in a non-transitory computer-readable medium such as system memory or another type of memory. In some cases, the code 1935 may not be directly executable by the processor 1940 but may cause a computer (e.g., when compiled and executed) to perform functions described herein. In some cases, the memory 1930 may contain, among other things, a BIOS which may control basic hardware or software operation such as the interaction with peripheral components or devices.

The processor 1940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1940 may be configured to operate a memory array using a memory controller. In some other cases, a memory controller may be integrated into the processor 1940. The processor 1940 may be configured to execute computer-readable instructions stored in a memory (e.g., the memory 1930) to cause the device 1905 to perform various functions (e.g., functions or tasks supporting sounding reference signal configuration and activation for partial frequency sounding). For example, the device 1905 or a component of the device 1905 may include a processor 1940 and memory 1930 coupled to the processor 1940, the processor 1940 and memory 1930 configured to perform various functions described herein.

The inter-station communications manager 1945 may manage communications with other base stations 105, and may include a controller or scheduler for controlling communications with UEs 115 in cooperation with other base stations 105. For example, the inter-station communications manager 1945 may coordinate scheduling for transmissions to UEs 115 for various interference mitigation techniques such as beamforming or joint transmission. In some examples, the inter-station communications manager 1945 may provide an X2 interface within an LTE/LTE-A wireless communications network technology to provide communication between base stations 105.

The communications manager 1920 may support wireless communication at a base station in accordance with examples as disclosed herein. For example, the communications manager 1920 may be configured as or otherwise support a means for transmitting, to a UE, control signaling identifying a configuration for a first sounding reference signal. The communications manager 1920 may be configured as or otherwise support a means for determining, based on the configuration and a set of parameters associated with partial frequency sounding of the first sounding reference signal, a subset of a set of resources configured for the first sounding reference signal, where the subset of the set of resources excludes at least one resource of the set of resources. The communications manager 1920 may be configured as or otherwise support a means for receiving, from the UE, a second sounding reference signal over the subset of the set of resources.

By including or configuring the communications manager 1920 in accordance with examples as described herein, the device 1905 may support techniques for the device 1905 to use fewer resources when receiving a sounding reference signal.

In some examples, the communications manager 1920 may be configured to perform various operations (e.g., receiving, monitoring, transmitting) using or otherwise in cooperation with the transceiver 1915, the one or more antennas 1925, or any combination thereof. Although the communications manager 1920 is illustrated as a separate component, in some examples, one or more functions described with reference to the communications manager 1920 may be supported by or performed by the processor 1940, the memory 1930, the code 1935, or any combination thereof. For example, the code 1935 may include instructions executable by the processor 1940 to cause the device 1905 to perform various aspects of sounding reference signal configuration and activation for partial frequency sounding as described herein, or the processor 1940 and the memory 1930 may be otherwise configured to perform or support such operations.

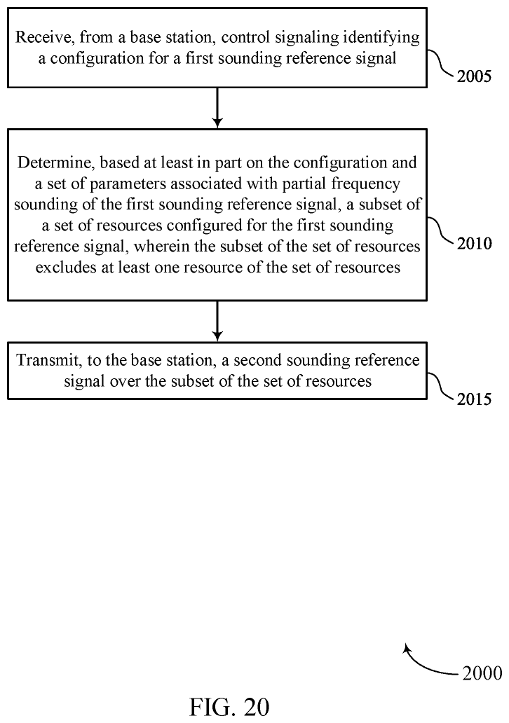

FIG. 20 shows a flowchart illustrating a method 2000 that supports sounding reference signal configuration and activation for partial frequency sounding in accordance with aspects of the present disclosure. The operations of the method 2000 may be implemented by a UE or its components as described herein. For example, the operations of the method 2000 may be performed by a UE 115 as described with reference to FIGS. 1 through 15. In some examples, a UE may execute a set of instructions to control the functional elements of the UE to perform the described functions. Additionally or alternatively, the UE may perform aspects of the described functions using special-purpose hardware.

At 2005, the method may include receiving, from a base station, control signaling identifying a configuration for a first sounding reference signal. The operations of 2005 may be performed in accordance with examples as disclosed herein. In some examples, aspects of the operations of 2005 may be performed by an SRS configuration receiver 1425 as described with reference to FIG. 14.

At 2010, the method may include determining, based on the configuration and a set of parameters associated with partial frequency sounding of the first sounding reference signal, a subset of a set of resources configured for the first sounding reference signal, where the subset of the set of resources excludes at least one resource of the set of resources. The operations of 2010 may be performed in accordance with examples as disclosed herein. In some examples, aspects of the operations of 2010 may be performed by a resource subset determiner 1430 as described with reference to FIG. 14.

At 2015, the method may include transmitting, to the base station, a second sounding reference signal over the subset of the set of resources. The operations of 2015 may be performed in accordance with examples as disclosed herein. In some examples, aspects of the operations of 2015 may be performed by an SRS transmitter 1435 as described with reference to FIG. 14.

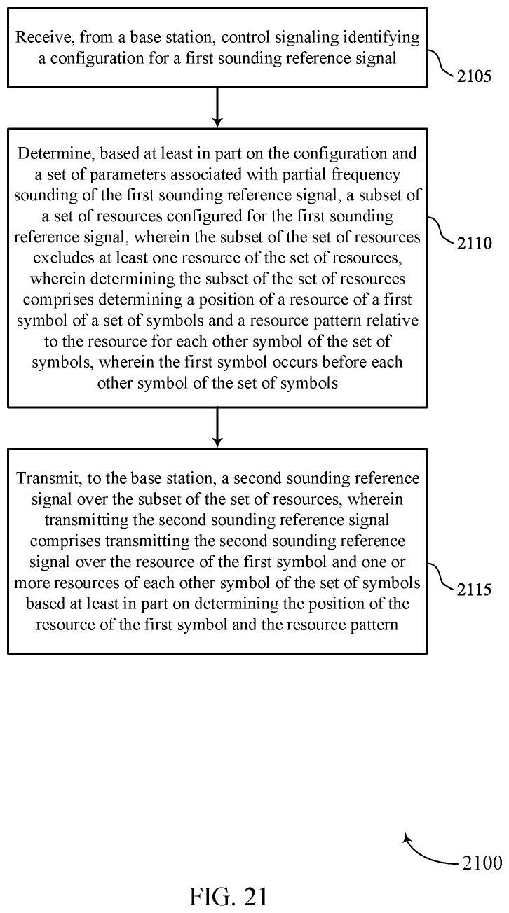

FIG. 21 shows a flowchart illustrating a method 2100 that supports sounding reference signal configuration and activation for partial frequency sounding in accordance with aspects of the present disclosure. The operations of the method 2100 may be implemented by a UE or its components as described herein. For example, the operations of the method 2100 may be performed by a UE 115 as described with reference to FIGS. 1 through 15. In some examples, a UE may execute a set of instructions to control the functional elements of the UE to perform the described functions. Additionally or alternatively, the UE may perform aspects of the described functions using special-purpose hardware.

At 2105, the method may include receiving, from a base station, control signaling identifying a configuration for a first sounding reference signal. The operations of 2105 may be performed in accordance with examples as disclosed herein. In some examples, aspects of the operations of 2105 may be performed by an SRS configuration receiver 1425 as described with reference to FIG. 14.

At 2110, the method may include determining, based on the configuration and a set of parameters associated with partial frequency sounding of the first sounding reference signal, a subset of a set of resources configured for the first sounding reference signal, where the subset of the set of resources excludes at least one resource of the set of resources, where determining the subset of the set of resources includes determining a position of a resource of a first symbol of a set of symbols and a resource pattern relative to the resource for each other symbol of the set of symbols, where the first symbol occurs before each other symbol of the set of symbols. The operations of 2110 may be performed in accordance with examples as disclosed herein. In some examples, aspects of the operations of 2110 may be performed by a resource subset determiner 1430 as described with reference to FIG. 14.

At 2115, the method may include transmitting, to the base station, a second sounding reference signal over the subset of the set of resources, where transmitting the second sounding reference signal includes transmitting the second sounding reference signal over the resource of the first symbol and one or more resources of each other symbol of the set of symbols based on determining the position of the resource of the first symbol and the resource pattern. The operations of 2115 may be performed in accordance with examples as disclosed herein. In some examples, aspects of the operations of 2115 may be performed by an SRS transmitter 1435 as described with reference to FIG. 14.

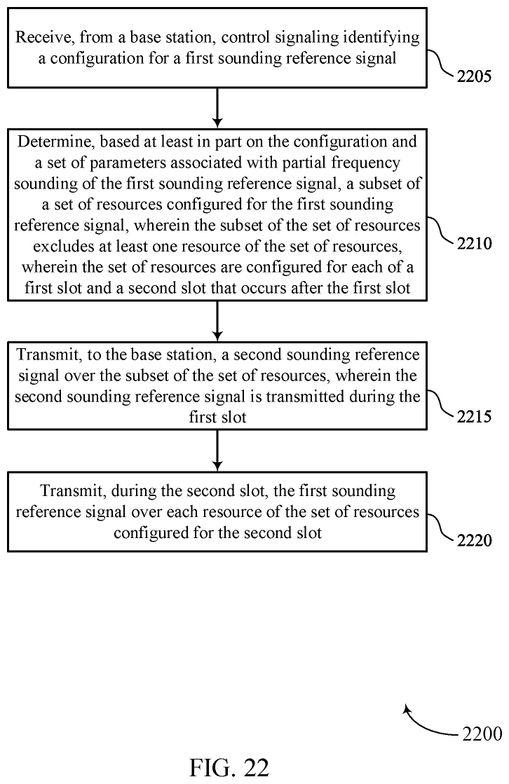

FIG. 22 shows a flowchart illustrating a method 2200 that supports sounding reference signal configuration and activation for partial frequency sounding in accordance with aspects of the present disclosure. The operations of the method 2200 may be implemented by a UE or its components as described herein. For example, the operations of the method 2200 may be performed by a UE 115 as described with reference to FIGS. 1 through 15. In some examples, a UE may execute a set of instructions to control the functional elements of the UE to perform the described functions. Additionally or alternatively, the UE may perform aspects of the described functions using special-purpose hardware.

At 2205, the method may include receiving, from a base station, control signaling identifying a configuration for a first sounding reference signal. The operations of 2205 may be performed in accordance with examples as disclosed herein. In some examples, aspects of the operations of 2205 may be performed by an SRS configuration receiver 1425 as described with reference to FIG. 14.

At 2210, the method may include determining, based on the configuration and a set of parameters associated with partial frequency sounding of the first sounding reference signal, a subset of a set of resources configured for the first sounding reference signal, where the subset of the set of resources excludes at least one resource of the set of resources, wherein the set of resources are configured for each of a first slot and a second slot that occurs after the first slot. The operations of 2210 may be performed in accordance with examples as disclosed herein. In some examples, aspects of the operations of 2210 may be performed by a resource subset determiner 1430 as described with reference to FIG. 14.

At 2215, the method may include transmitting, to the base station, a second sounding reference signal over the subset of the set of resources, wherein the second sounding reference signal is transmitted during the first slot. The operations of 2215 may be performed in accordance with examples as disclosed herein. In some examples, aspects of the operations of 2215 may be performed by an SRS transmitter 1435 as described with reference to FIG. 14.

At 2220, the method may include transmitting, during the second slot, the first sounding reference signal over each resource of the set of resources configured for the second slot. The operations of 2220 may be performed in accordance with examples as disclosed herein. In some examples, aspects of the operations of 2220 may be performed by an SRS transmitter 1435 as described with reference to FIG. 14.

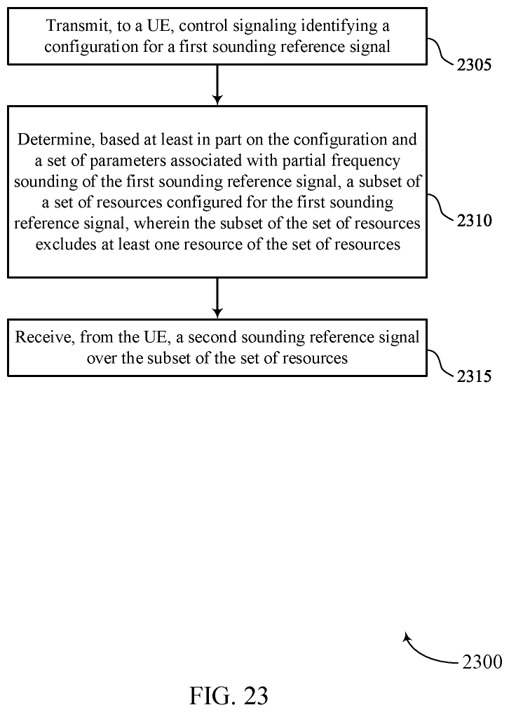

FIG. 23 shows a flowchart illustrating a method 2300 that supports sounding reference signal configuration and activation for partial frequency sounding in accordance with aspects of the present disclosure. The operations of the method 2300 may be implemented by a base station or its components as described herein. For example, the operations of the method 2300 may be performed by a base station 105 as described with reference to FIGS. 1 through 11 and 16 through 19. In some examples, a base station may execute a set of instructions to control the functional elements of the base station to perform the described functions. Additionally or alternatively, the base station may perform aspects of the described functions using special-purpose hardware.

At 2305, the method may include transmitting, to a UE, control signaling identifying a configuration for a first sounding reference signal. The operations of 2305 may be performed in accordance with examples as disclosed herein. In some examples, aspects of the operations of 2305 may be performed by an SRS configuration transmitter 1825 as described with reference to FIG. 18.

At 2310, the method may include determining, based on the configuration and a set of parameters associated with partial frequency sounding of the first sounding reference signal, a subset of a set of resources configured for the first sounding reference signal, where the subset of the set of resources excludes at least one resource of the set of resources. The operations of 2310 may be performed in accordance with examples as disclosed herein. In some examples, aspects of the operations of 2310 may be performed by a resource subset determination component 1830 as described with reference to FIG. 18.

At 2315, the method may include receiving, from the UE, a second sounding reference signal over the subset of the set of resources. The operations of 2315 may be performed in accordance with examples as disclosed herein. In some examples, aspects of the operations of 2315 may be performed by an SRS receiver 1835 as described with reference to FIG. 18.

The following provides an overview of aspects of the present disclosure:

Aspect 1: A method for wireless communication at a UE, comprising: receiving, from a base station, control signaling identifying a configuration for a first sounding reference signal; determining, based at least in part on the configuration and a set of parameters associated with partial frequency sounding of the first sounding reference signal, a subset of a set of resources configured for the first sounding reference signal, wherein the subset of the set of resources excludes at least one resource of the set of resources; and transmitting, to the base station, a second sounding reference signal over the subset of the set of resources.

Aspect 2: The method of aspect 1, wherein determining the subset of the set of resources comprises determining a position of a resource of a first symbol of a set of symbols and a resource pattern relative to the resource for each other symbol of the set of symbols, wherein the first symbol occurs before each other symbol of the set of symbols; and transmitting the second sounding reference signal comprises transmitting the second sounding reference signal over the resource of the first symbol and one or more resources of each other symbol of the set of symbols based at least in part on determining the position of the resource of the first symbol and the resource pattern.

Aspect 3: The method of aspect 2, further comprising: receiving an indication of the set of parameters that comprises a first parameter, wherein determining the position of the resource of the first symbol of the set of symbols is based at least in part on the first parameter, wherein transmitting the second sounding reference signal comprises transmitting the second sounding reference signal over the resource of the first symbol based at least in part on the first parameter.

Aspect 4: The method of any of aspects 2 through 3, further comprising: receiving an indication of the set of parameters that comprises a first parameter, wherein determining the resource pattern relative to the resource for each other symbol of the set of symbols is based at least in part on the first parameter.

Aspect 5: The method of aspect 4, wherein the resource pattern comprises a frequency hopping pattern based at least in part on the first parameter failing to satisfy a threshold.

Aspect 6: The method of any of aspects 2 through 5, further comprising: receiving medium access control (MAC) control element signaling that reconfigures the position of the resource, the resource pattern, or both; transmitting a third sounding reference signal according to the reconfigured position of the resource, the reconfigured resource pattern, or both.

Aspect 7: The method of aspect 6, further comprising: receiving the MAC control element signaling before transmitting the second sounding reference signal, wherein transmitting the second sounding reference signal according to the position of the resource of the first symbol and the resource pattern is based at least in part on receiving the MAC control element signaling within a threshold time relative to transmitting the second sounding reference signal, and wherein transmitting the third sounding reference signal according to the reconfigured position of the resource, the reconfigured resource pattern, or both is based at least in part on receiving the MAC control element signaling prior to the threshold time relative to transmitting the third sounding reference signal.

Aspect 8: The method of any of aspects 1 through 7, wherein . the set of resources are associated with a set of symbols, each symbol of the set of symbols is associated with two or more resources of the set of resources that are contiguous with each other, the two or more resources for each symbol have an order, determining the subset of the set of resources comprises determining an index for the each symbol, and a position in the order for the subset of the set of resources for the each symbol is based at least in part on the corresponding index

Aspect 9: The method of aspect 8, wherein each index is based at least in part on a position of the corresponding symbol relative to each other symbol of the set of symbols.

Aspect 10: The method of any of aspects 8 through 9, wherein each index is based at least in part on a hop number associated with the symbol corresponding to each index.

Aspect 11: The method of any of aspects 1 through 10, wherein the set of resources are configured for each of a first slot and a second slot that occurs after the first slot, wherein the second sounding reference signal is transmitted during the first slot, the method further comprising: transmitting, during the second slot, the first sounding reference signal over each resource of the set of resources configured for the second slot.

Aspect 12: The method of aspect 11, further comprising: determining, after transmitting the second sounding reference signal, that a measurement gap is larger than a threshold, that bandwidth part switching has occurred, or both, wherein transmitting the first sounding reference signal over each resource of the set of resources configured for the second slot is based at least in part on determining that the measurement gap is larger than the threshold, that bandwidth part switching has occurred, or both.

Aspect 13: The method of any of aspects 1 through 12, further comprising: identifying a sequence of indices associated with a sequence of symbols comprising respective resources of the subset of the set of resources; and refraining from transmitting the second sounding reference signal during a first symbol the sequence of symbols based at least in part on identifying a gap comprising the first symbol, wherein transmitting the second sounding reference signal comprises transmitting the second sounding reference signal in a second symbol of the sequence of symbols subsequent to the gap according to a corresponding index of the sequence of indices.

Aspect 14: The method of any of aspects 1 through 13, further comprising: identifying a sequence of indices associated with a sequence of symbols comprising respective resources of the subset of the set of resources; refraining from transmitting the second sounding reference signal during a first symbol the sequence of symbols based at least in part on identifying a gap comprising the first symbol; and resetting the sequence of indices at a second symbol subsequent to the gap such that the second symbol is associated with an initial index of the sequence of indices based at least in part on the first symbol being within the gap, wherein transmitting the second sounding reference signal comprises transmitting the second sounding reference signal in the second symbol based at least in part on the initial index.

Aspect 15: The method of any of aspects 1 through 14, further comprising: identifying a sequence of indices associated with a sequence of symbols comprising respective resources of the subset of the set of resources; refraining from transmitting the second sounding reference signal during a first symbol the sequence of symbols based at least in part on identifying a gap comprising the first symbol; and deferring an index of the sequence of indices corresponding to the first symbol to a second symbol subsequent to the gap, wherein transmitting the second sounding reference signal comprises transmitting the second sounding reference signal in the second symbol based at least in part on the deferred index.

Aspect 16: A method for wireless communication at a base station, comprising: transmitting, to a UE, control signaling identifying a configuration for a first sounding reference signal; determining, based at least in part on the configuration and a set of parameters associated with partial frequency sounding of the first sounding reference signal, a subset of a set of resources configured for the first sounding reference signal, wherein the subset of the set of resources excludes at least one resource of the set of resources; and receiving, from the UE, a second sounding reference signal over the subset of the set of resources.

Aspect 17: The method of aspect 16, wherein determining the subset of the set of resources comprises determining a position of a resource of a first symbol of a set of symbols and a resource pattern relative to the resource for each other symbol of the set of symbols, wherein the first symbol occurs before each other symbol of the set of symbols; and receiving the second sounding reference signal comprises receiving the second sounding reference signal over the resource of the first symbol and one or more resources of each other symbol of the set of symbols based at least in part on determining the position of the resource of the first symbol and the resource pattern.

Aspect 18: The method of any of aspects 16 through 17, wherein . the set of resources are associated with a set of symbols, each symbol of the set of symbols is associated with two or more resources of the set of resources that are contiguous with each other, the two or more resources for each symbol have an order, determining the subset of the set of resources comprises determining an index for the each symbol, and a position in the order for the subset of the set of resources for the each symbol is based at least in part on the corresponding index

Aspect 19: The method of any of aspects 16 through 18, wherein the set of resources are configured for each of a first slot and a second slot that occurs after the first slot, wherein the second sounding reference signal is received during the first slot, the method further comprising: receiving, during the second slot, the first sounding reference signal over each resource of the set of resources configured for the second slot.

Aspect 20: The method of any of aspects 16 through 19, further comprising: identifying a sequence of indices associated with a sequence of symbols comprising respective resources of the subset of the set of resources; and refraining from receiving the second sounding reference signal during a first symbol the sequence of symbols based at least in part on identifying a gap comprising the first symbol, wherein receiving the second sounding reference signal comprises receiving the second sounding reference signal in a second symbol of the sequence of symbols subsequent to the gap according to a corresponding index of the sequence of indices.

Aspect 21: The method of any of aspects 16 through 20, further comprising: identifying a sequence of indices associated with a sequence of symbols comprising respective resources of the subset of the set of resources; refraining from receiving the second sounding reference signal during a first symbol the sequence of symbols based at least in part on identifying a gap comprising the first symbol; and resetting the sequence of indices at a second symbol subsequent to the gap such that the second symbol is associated with an initial index of the sequence of indices based at least in part on the first symbol being within the gap, wherein receiving the second sounding reference signal comprises receiving the second sounding reference signal in the second symbol based at least in part on the initial index.

Aspect 22: The method of any of aspects 16 through 21, further comprising: identifying a sequence of indices associated with a sequence of symbols comprising respective resources of the subset of the set of resources; refraining from receiving the second sounding reference signal during a first symbol the sequence of symbols based at least in part on identifying a gap comprising the first symbol; and deferring an index of the sequence of indices corresponding to the first symbol to a second symbol subsequent to the gap, wherein receiving the second sounding reference signal comprises receiving the second sounding reference signal in the second symbol based at least in part on the deferred index.

Aspect 23: An apparatus for wireless communication at a UE, comprising a processor; memory coupled with the processor; and instructions stored in the memory and executable by the processor to cause the apparatus to perform a method of any of aspects 1 through 15.

Aspect 24: An apparatus for wireless communication at a UE, comprising at least one means for performing a method of any of aspects 1 through 15.

Aspect 25: A non-transitory computer-readable medium storing code for wireless communication at a UE, the code comprising instructions executable by a processor to perform a method of any of aspects 1 through 15.

Aspect 26: An apparatus for wireless communication at a base station, comprising a processor; memory coupled with the processor; and instructions stored in the memory and executable by the processor to cause the apparatus to perform a method of any of aspects 16 through 22.

Aspect 27: An apparatus for wireless communication at a base station, comprising at least one means for performing a method of any of aspects 16 through 22.

Aspect 28: A non-transitory computer-readable medium storing code for wireless communication at a base station, the code comprising instructions executable by a processor to perform a method of any of aspects 16 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a base station, control signaling identifying a configuration for a first sounding reference signal;
determining, based at least in part on the configuration and a set of parameters associated with partial frequency sounding of the first sounding reference signal, a subset of a set of resources configured for the first sounding reference signal, wherein the subset of the set of resources excludes at least one resource of the set of resources; and
transmitting, to the base station, a second sounding reference signal over the subset of the set of resources.

2. The method of claim 1, wherein:
determining the subset of the set of resources comprises determining a position of a resource of a first symbol of a set of symbols and a resource pattern relative to the resource for each other symbol of the set of symbols, wherein the first symbol occurs before each other symbol of the set of symbols; and
transmitting the second sounding reference signal comprises transmitting the second sounding reference signal over the resource of the first symbol and one or more resources of each other symbol of the set of symbols based at least in part on determining the position of the resource of the first symbol and the resource pattern.

3. The method of claim 2, further comprising:
receiving an indication of the set of parameters that comprises a first parameter, wherein determining the position of the resource of the first symbol of the set of symbols is based at least in part on the first parameter, wherein transmitting the second ounding reference signal comprises transmitting the second sounding reference signal over the resource of the first symbol based at least in part on the first parameter.

4. The method of claim 2, further comprising:
receiving an indication of the set of parameters that comprises a first parameter, wherein determining the resource pattern relative to the resource for each other symbol of the set of symbols is based at least in part on the first parameter.

5. The method of claim 4, wherein the resource pattern comprises a frequency hopping pattern based at least in part on the first parameter failing to satisfy a threshold.

6. The method of claim 2, further comprising:
receiving medium access control (MAC) control element signaling that reconfigures the position of the resource, the resource pattern, or both;
transmitting a third sounding reference signal according to the reconfigured position of the resource, the reconfigured resource pattern, or both.

7. The method of claim 6, further comprising:
receiving the MAC control element signaling before transmitting the second sounding reference signal, wherein transmitting the second sounding reference signal according to the position of the resource of the first symbol and the resource pattern is based at least in part on receiving the MAC control element signaling within a threshold time relative to transmitting the second sounding reference signal, and wherein transmitting the third sounding reference signal according to the reconfigured position of the resource, the reconfigured resource pattern, or both is based at least in part on receiving the MAC control element signaling prior to the threshold time relative to transmitting the third sounding reference signal.

8. The method of claim 1, wherein
the set of resources are associated with a set of symbols,
each symbol of the set of symbols is associated with two or more resources of the set of resources that are contiguous with each other,
the two or more resources for each symbol have an order,
determining the subset of the set of resources comprises determining an index for the each symbol, and
a position in the order for the subset of the set of resources for the each symbol is based at least in part on the corresponding index.

9. The method of claim 8, wherein each index is based at least in part on a position of the corresponding symbol relative to each other symbol of the set of symbols.

10. The method of claim 8, wherein each index is based at least in part on a hop number associated with the symbol corresponding to each index.

11. The method of claim 1, wherein the set of resources are configured for each of a first slot and a second slot that occurs after the first slot, wherein the second sounding reference signal is transmitted during the first slot, the method further comprising:
transmitting, during the second slot, the first sounding reference signal over each resource of the set of resources configured for the second slot.

12. The method of claim 11, further comprising:
determining, after transmitting the second sounding reference signal, that a measurement gap is larger than a threshold, that bandwidth part switching has occurred, or both, wherein transmitting the first sounding reference signal over each resource of the set of resources configured for the second slot is based at least in part on determining that the measurement gap is larger than the threshold, that bandwidth part switching has occurred, or both.

13. The method of claim 1, further comprising:
identifying a sequence of indices associated with a sequence of symbols comprising respective resources of the subset of the set of resources; and
refraining from transmitting the second sounding reference signal during a first symbol the sequence of symbols based at least in part on identifying a gap comprising the first symbol, wherein transmitting the second sounding reference signal comprises transmitting the second sounding reference signal in a second symbol of the sequence of symbols subsequent to the gap according to a corresponding index of the sequence of indices.

14. The method of claim 1, further comprising:
identifying a sequence of indices associated with a sequence of symbols comprising respective resources of the subset of the set of resources;
refraining from transmitting the second sounding reference signal during a first symbol the sequence of symbols based at least in part on identifying a gap comprising the first symbol; and
resetting the sequence of indices at a second symbol subsequent to the gap such that the second symbol is associated with an initial index of the sequence of indices based at least in part on the first symbol being within the gap, wherein transmitting the second sounding reference signal comprises transmitting the second sounding reference signal in the second symbol based at least in part on the initial index.

15. The method of claim 1, further comprising:
identifying a sequence of indices associated with a sequence of symbols comprising respective resources of the subset of the set of resources;
refraining from transmitting the second sounding reference signal during a first symbol the sequence of symbols based at least in part on identifying a gap comprising the first symbol; and
deferring an index of the sequence of indices corresponding to the first symbol to a second symbol subsequent to the gap, wherein transmitting the second sounding reference signal comprises transmitting the second sounding reference signal in the second symbol based at least in part on the deferred index.

16. A method for wireless communication at a base station, comprising:
transmitting, to a user equipment (UE), control signaling identifying a configuration for a first sounding reference signal;
determining, based at least in part on the configuration and a set of parameters associated with partial frequency sounding of the first sounding reference signal, a subset of a set of resources configured for the first sounding reference signal, wherein the subset of the set of resources excludes at least one resource of the set of resources; and
receiving, from the UE, a second sounding reference signal over the subset of the set of resources.

17. The method of claim 16, wherein:
determining the subset of the set of resources comprises determining a position of a resource of a first symbol of a set of symbols and a resource pattern relative to the resource for each other symbol of the set of symbols, wherein the first symbol occurs before each other symbol of the set of symbols; and
receiving the second sounding reference signal comprises receiving the second sounding reference signal over the resource of the first symbol and one or more resources of each other symbol of the set of symbols based at least in part on determining the position of the resource of the first symbol and the resource pattern.

18. The method of claim 16, wherein
the set of resources are associated with a set of symbols,
each symbol of the set of symbols is associated with two or more resources of the set of resources that are contiguous with each other,
the two or more resources for each symbol have an order,
determining the subset of the set of resources comprises determining an index for the each symbol, and
a position in the order for the subset of the set of resources for the each symbol is based at least in part on the corresponding index.

19. The method of claim 16, wherein the set of resources are configured for each of a first slot and a second slot that occurs after the first slot, wherein the second sounding reference signal is received during the first slot, the method further comprising:
receiving, during the second slot, the first sounding reference signal over each resource of the set of resources configured for the second slot.

20. The method of claim 16, further comprising:
identifying a sequence of indices associated with a sequence of symbols comprising respective resources of the subset of the set of resources; and
refraining from receiving the second sounding reference signal during a first symbol the sequence of symbols based at least in part on identifying a gap comprising the first symbol, wherein receiving the second sounding reference signal comprises receiving the second sounding reference signal in a second symbol of the sequence of symbols subsequent to the gap according to a corresponding index of the sequence of indices.

21. The method of claim 16, further comprising:
identifying a sequence of indices associated with a sequence of symbols comprising respective resources of the subset of the set of resources;
refraining from receiving the second sounding reference signal during a first symbol the sequence of symbols based at least in part on identifying a gap comprising the first symbol; and
resetting the sequence of indices at a second symbol subsequent to the gap such that the second symbol is associated with an initial index of the sequence of indices based at least in part on the first symbol being within the gap, wherein receiving the second sounding reference signal comprises receiving the second sounding reference signal in the second symbol based at least in part on the initial index.

22. The method of claim 16, further comprising:
identifying a sequence of indices associated with a sequence of symbols comprising respective resources of the subset of the set of resources;
refraining from receiving the second sounding reference signal during a first symbol the sequence of symbols based at least in part on identifying a gap comprising the first symbol; and
deferring an index of the sequence of indices corresponding to the first symbol to a second symbol subsequent to the gap, wherein receiving the second sounding reference signal comprises receiving the second sounding reference signal in the second symbol based at least in part on the deferred index.

23. An apparatus for wireless communication at a user equipment (UE), comprising:
a processor;
memory coupled with the processor; and
instructions stored in the memory and executable by the processor to cause the apparatus to:
receive, from a base station, control signaling identifying a configuration for a first sounding reference signal;
determine, based at least in part on the configuration and a set of parameters associated with partial frequency sounding of the first sounding reference signal, a subset of a set of resources configured for the first sounding reference signal, wherein the subset of the set of resources excludes at least one resource of the set of resources; and
transmit, to the base station, a second sounding reference signal over the subset of the set of resources.

24. The apparatus of claim 23, wherein:
the instructions to determine the subset of the set of resources are executable by the processor to cause the apparatus to determine a position of a resource of a first symbol of a set of symbols and a resource pattern relative to the resource for each other symbol of the set of symbols, wherein the first symbol occurs before each other symbol of the set of symbols; and
the instructions to transmit the second sounding reference signal are executable by the processor to cause the apparatus to transmit the second sounding reference signal over the resource of the first symbol and one or more resources of each other symbol of the set of symbols based at least in part on determining the position of the resource of the first symbol and the resource pattern.

25. The apparatus of claim 24, wherein the instructions are further executable by the processor to cause the apparatus to:
receive an indication of the set of parameters that comprises a first parameter, wherein determining the position of the resource of the first symbol of the set of symbols is based at least in part on the first parameter, wherein transmitting the second sounding reference signal comprises transmitting the second sounding reference signal over the resource of the first symbol based at least in part on the first parameter.

26. The apparatus of claim 24, wherein the instructions are further executable by the processor to cause the apparatus to:
receive an indication of the set of parameters that comprises a first parameter, wherein determining the resource pattern relative to the resource for each other symbol of the set of symbols is based at least in part on the first parameter.

27. The apparatus of claim 26, wherein the resource pattern comprises a frequency hopping pattern based at least in part on the first parameter failing to satisfy a threshold.

28. The apparatus of claim 24, wherein the instructions are further executable by the processor to cause the apparatus to:
receive medium access control (MAC) control element signaling that reconfigures the position of the resource, the resource pattern, or both;
transmit a third sounding reference signal according to the reconfigured position of the resource, the reconfigured resource pattern, or both.

29. The apparatus of claim 28, wherein the instructions are further executable by the processor to cause the apparatus to:
receive the MAC control element signaling before transmitting the second sounding reference signal, wherein transmitting the second sounding reference signal according to the position of the resource of the first symbol and the resource pattern is based at least in part on receiving the MAC control element signaling within a threshold time relative to transmitting the second sounding reference signal, and wherein transmitting the third sounding reference signal according to the reconfigured position of the resource, the reconfigured resource pattern, or both is based at least in part on receiving the MAC control element signaling prior to the threshold time relative to transmitting the third sounding reference signal.

30. An apparatus for wireless communication at a base station, comprising:
a processor;
memory coupled with the processor; and
instructions stored in the memory and executable by the processor to cause the apparatus to:
transmit, to a user equipment (UE), control signaling identifying a configuration for a first sounding reference signal;
determine, based at least in part on the configuration and a set of parameters associated with partial frequency sounding of the first sounding reference signal, a subset of a set of resources configured for the first sounding reference signal, wherein the subset of the set of resources excludes at least one resource of the set of resources; and
receive, from the UE, a second sounding reference signal over the subset of the set of resources.
